(19) United States
(12) Patent Application Publication
(10) Pub. No.: US 2009/0090462 A1
(43) Pub. Date: Apr. 9, 2009

(54) Electromagnetic Wave Shielding Laminate and Production Method Therefor

(76) Inventors: Shigemoto Kato, Tokyo (JP); Kazuhito Tokutome, Tokyo (JP); Noribumi Ideyoshi, Tokyo (JP); Tomohiro Tsuruta, Tokyo (JP); Shinichi Usui, Tokyo (JP); Toshinori Machida, Tokyo (JP); Naotoshi Nakamura, Tokyo (JP); Yukihiro Ueda, Tokyo (JP)

Correspondence Address: MCDERMOTT WILL & EMERY LLP, 600 13TH STREET, N.W., WASHINGTON, DC, 20005-3096, US

(21) Appl. No.: 11/921,416

(22) PCT Filed: Jun. 1, 2006
(86) PCT No.: PCT/JP2006/311021

§ 371 Date: Nov. 30, 2007

(30) Foreign Application Priority Data
Jun. 2, 2005 (JP) 2005-163288

(51) Int. Cl. B32B 37/00

(52) U.S. Cl. 156/249

(57) ABSTRACT

A production method for an electromagnetic wave shielding laminate comprising the step of forming a geometric-form electromagnetic wave shielding material on a releasable support, and the steps of separating the electromagnetic wave shielding material from the releasable support and transferring it onto a transfer support formed of at least one function layer provided on one or both surfaces thereof with at least one function of conductivity, anti-reflection function, reflection-reducing function, hard-coat property, anti-glare function, anti-staining function, near infrared ray absorbing function, ultraviolet ray absorbing function, color correcting function, radiating function, Ne cutting function, anti-scattering function, and shock relieving function.

### TECHNICAL FIELD

The present invention relates to a transparent laminate with an electromagnetic wave shielding function and other functions, which can be preferably used as a display front plate of a display such as a CRT, a plasma display panel, a fluorescent display tube, and a field emission display, and a production method thereof.

### BACKGROUND ART

Electromagnetic waves (microwaves) leakage from various displays such as a CRT and a plasma display and electronic devices have been a problem in recent years. Because of this, an electromagnetic wave shielding plate is pasted on a display front surface to thereby shield electromagnetic waves leakage from a display. Because the electromagnetic wave shielding plate is provided on the front face of the display, superior transparency is also required together with the electromagnetic wave shielding property. From such a viewpoint, in the prior art, there has been a need for an electromagnetic wave shielding plate that has superior properties in the electromagnetic wave shielding property and transparency.

Conventionally, an electromagnetic wave shielding plate has been prepared by laminating copper foil on a base material film through an adhesive, and then etching the copper foil to form a geometric-form copper foil pattern (for example, refer to Patent Documents 1 to 3 below). Then, because the electromagnetic wave shielding plate is mounted on a display face of various displays such as a plasma display, the geometric-form copper foil pattern is subjected to a blackening treatment in some cases, for the purpose of improving the contrast of a display screen. Further, the electromagnetic wave shielding plate is pasted with a functional layer such as an antireflective layer, a hard coat layer, a near infrared ray absorbing layer, and a color correcting layer, and mounted on the front face of a display, etc. (for example, refer to Patent Document 4 below).

### Patent Document 1: Japanese Patent No. 3480898

### Patent Document 2: Japanese Patent Application Laid-Open (JP-A) No. 2000-323890

### Patent Document 3: JP-A-2000-323891

### Patent Document 4: JP-A-2003-195774

Some examples of the conventional electromagnetic wave shielding plates were shown in FIGS. 4 and 5. The electromagnetic wave shielding plate in FIG. 4 is constituted in such a manner that a sheet, which is obtained by forming a hard coat layer 4 and an antireflective layer 5 on one face of a support 1a, and an electromagnetic wave shielding sheet, which is obtained by forming an adhesive or pressure-sensitive adhesive layer 3, an electromagnetic wave shielding layer 2, and a resin layer 7 covering the layer 2 on another support 1a, are laminated through a near infrared rays absorbing layer 6. The electromagnetic wave shielding plate in FIG. 5 is provided by pasting a sheet obtained by forming a hard coat layer 4 and an antireflective layer 5 on one face of a support 1a, a near infrared ray absorbing sheet obtained by forming a near infrared ray absorbing layer 6 on another support 1a, and an electromagnetic wave shielding sheet obtained by forming an adhesive or pressure-sensitive adhesive layer 3 and a resin layer 7 covering the layer 3 on still another support 1a, through the adhesive or pressure-sensitive adhesive layers 3.

However, in the conventional method, as each functional layer is pasted to a base material film in order to provide various functional layers to the electromagnetic wave shielding plate, there is a necessity of using an adhesive or pressure-sensitive adhesive layer for each functional layer. Thus, the amount of transmitted light decreases and the transparency decreases (the haze value increases) due to the large amount of the adhesive or pressure-sensitive adhesive. Additionally, as a base material film is used for each functional layer, the consequent weight load resulting therefrom, etc. has been a problem. Further, there are many production steps when producing a multi-layer electromagnetic wave shielding plate, which poses problems such as increase of causes of product defects, complication of production steps, the multi-layering of the product configuration, and the production cost.

In order to solve the problems, a method can be considered in which a geometric-form copper foil is provided in advance on a base material of an electromagnetic wave shielding plate, and then each functional layer is laminated on the back of the base material. However, in this method, a new problem rises that the copper foil may be peeled off by contact of the copper foil with rolls, or in the case that the copper foil has been subjected to a blackening treatment, a blackened part may be peeled off by contact of the blackened part with a roll, when produced with a roll-to-roll. Thus, a new problem that has to countermeasure against the problems rises.

### DISCLOSURE OF THE INVENTION

### Problems to be Solved by the Invention

Therefore, an object of the present invention is to provide an electromagnetic wave shielding laminate that does not have the problems as described above, and a production method thereof.

More specifically, another object of the present invention is to provide an electromagnetic wave shielding laminate having a functional layer in which the number of base materials is reduced and the weight load is reduced compared with the conventional electromagnetic wave shielding plate, and which shows no decrease in the amount of transmitted light and transparency and no increase of a haze value, without defect such as peeling of the electromagnetic wave shielding material.

Still another object of the present invention is to provide an electromagnetic wave shielding laminate superior in the characteristics, which can be preferably used as a front plate of various displays, etc.

Further another object of the present invention is to provide a method of producing an electromagnetic wave shielding laminate having a functional layer in which there is no decrease in the amount of transmitted light, no decrease of transparency, no increase of a haze value, and no defect such as peeling of an electromagnetic wave shielding material, and that can be preferably used as a front plate of various displays, etc. with fewer production steps, less used amount of an adhesive or pressure-sensitive adhesive, and without generation of product defects.

Still another object of the present invention is to provide a method of forming an electromagnetic wave shielding body superior in the characteristics using only one base material film when various functional layers are formed.

### Means for Solving the Problems

The present invention relates to a production method for an electromagnetic wave shielding laminate, comprising a step of forming a geometric-form electromagnetic wave shielding material on a releasable support, a step of separating the electromagnetic wave shielding material from the releasable support, and a step of transferring the electromagnetic wave shielding material onto a transfer support, on one or both surfaces of which at least one functional layer with at least one function of conductivity, an anti-reflection function, a reflection-reducing function, a hard-coat property, an anti-glare function, an anti-staining function, a near infrared ray absorbing function, an ultraviolet ray absorbing function, a color correcting function, a radiating function, a Ne cutting function, an anti-scattering function, and a shock relieving function is formed.

The invention relates to the production method for an electromagnetic wave shielding laminate described above, wherein the step of forming a geometric-form electromagnetic wave shielding material on a releasable support comprises a step of pasting a metal foil onto the support through a first adhesive or pressure-sensitive adhesive and a step of forming the metal foil into a geometric-form by an etching method.

The invention relates to the production methods for an electromagnetic wave shielding laminate described above, wherein the first adhesive or pressure-sensitive adhesive is an adhesive of active energy ray adhesive force vanishing type.

The invention relates to the production methods for an electromagnetic wave shielding laminate described above, wherein the step of forming an electromagnetic wave shielding material by transferring includes a step of separating the electromagnetic wave shielding material from the releasable support.

The invention relates to the production methods for an electromagnetic wave shielding laminate described above, wherein the step of forming an electromagnetic wave shielding material by transferring includes a step of vanishing away an adhesive or pressure-sensitive adhesive force of the first adhesive or pressure-sensitive adhesive by irradiation with active energy rays.

The invention relates to the production methods for an electromagnetic wave shielding laminate described above, further comprising a step of conducting a blackening treatment on the geometric-form electromagnetic wave shielding material.

The invention relates to the production methods for an electromagnetic wave shielding laminate described above, wherein the electromagnetic wave shielding material is formed by transferring onto a transfer support through a second adhesive or pressure-sensitive adhesive in the step of forming the electromagnetic wave shielding material by transferring.

The invention relates to the production method for an electromagnetic wave shielding laminate described above, wherein the second adhesive or pressure-sensitive adhesive has at leas one function of a near infrared ray absorbing function, a Ne cutting function, a color correcting function, a radiating function, and an anti-scattering function.

The invention relates to the production methods for an electromagnetic wave shielding laminate described above, wherein the electromagnetic wave shielding material formed by transferring onto the transfer support is covered with the second adhesive or pressure-sensitive adhesive.

The invention relates to the production methods for an electromagnetic wave shielding laminate described above, wherein the electromagnetic wave shielding material formed by transferring onto the transfer support is covered with the second adhesive or pressure-sensitive adhesive, and a part of the material is exposed from the second adhesive or pressure-sensitive adhesive.

The present invention also relates to an electromagnetic wave shielding laminate produced by the production method.

### EFFECT OF THE INVENTION

According to the invention, an electromagnetic wave shielding laminate having a functional layer can be formed with one supporting base material, which leads to reduction in number of adhesive or pressure-sensitive adhesive layers. This enables improvements in light transmittance, transparency (decrease of the haze value), reduced weight, yield, cost performance, etc.

Because an electromagnetic wave shielding material having a geometric form is formed by transferring to a transfer support having a functional layer, the electromagnetic wave shielding laminate having the electromagnetic wave shielding material and the functional layer can be provided with one base material. Accordingly, it is possible to prevent problems such as weight load, decrease of the amount of transmitted light, decrease of transparency, increase of the haze value, cost, and failure rate.

### BRIEF DESCRIPTION OF THE DRAWINGS

FIG. 1 is a cross-sectional view showing one example of an electromagnetic wave shielding laminate of the present invention.

FIG. 2 is a cross-sectional view showing another example of the electromagnetic wave shielding laminate of the invention.

FIG. 3 is a cross-sectional view showing still another example of the electromagnetic wave shielding laminate of the invention.

FIG. 4 is a cross-sectional view showing one example of a conventional electromagnetic shielding laminate.

FIG. 5 is a cross-sectional view showing another example of the conventional electromagnetic shielding laminate.

### EXPLANATION OF REFERENCE NUMERALS

In FIGS. 1 to 5, reference numeral 1 is a transfer support, 1a is a support, 2 is an electromagnetic shielding material, 3 is a second adhesive or pressure-sensitive adhesive, 3a is a second adhesive or pressure-sensitive adhesive (including a near infrared ray absorbing agent), 4 is a hard coat layer, 5 is an antireflective layer, 6 is a near infrared ray absorbing layer, 7 is a resin layer, 8 is an adhesive or pressure-sensitive adhesive (including a color correcting agent), and 9 is a panel of a plasma display.

### BEST MODE FOR CARRYING OUT THE INVENTION

Hereinafter, the present invention will be explained in more detail. In a production method for the electromagnetic wave shielding material in the invention, first, an electromagnetic wave shielding material is formed on a releasable support, and the electromagnetic wave shielding material is released from the releasable support and transferred onto a transfer support. At this time, releasing of the electromagnetic wave shielding material from the releasable support and transferring it onto the transfer support may be performed in separate steps or may be performed in the same step. More specifically, the electromagnetic wave shielding material may be separated and transferred onto another support temporarily, and then the transferred electromagnetic wave shielding material may be transferred onto the transfer support having various functional layers. Preferably, separating of the electromagnetic shielding material from the releasable support and transferring it onto the transfer support are conducted at the same time. In this case, it is necessary to separate the electromagnetic wave shielding material from the releasable support and transfer it onto a support such as a transfer support. For this reason, an adhesion force (pressure-sensitive adhesive force or adhesive strength) of the releasable support to the electromagnetic wave shielding material has to be smaller compared with the adhesion force of a support such as a transfer support to the electromagnetic shielding material. That is, the term “releasability” used herein is to have a smaller adhesion force to the electromagnetic wave shielding material when the electromagnetic wave shielding material is transferred to a support such as a transfer support than the adhesion force of the transfer support to the electromagnetic wave shielding material.

In the present invention, any releasable support may be used as long as the function as a support can be maintained toward the electromagnetic wave shielding material when the electromagnetic wave shielding material is formed and the electromagnetic shielding material can be formed on the support. The releasable support may be composed of a base material unit, and may be provided with an adhesive or pressure-sensitive adhesive (first adhesive or pressure-sensitive adhesive) layer on a base material thereof. The first adhesive or pressure-sensitive adhesive layer may be formed by applying an adhesive or pressure-sensitive adhesive on a base material or by transferring an adhesive or pressure-sensitive adhesive layer formed on another releasable support in advance to a base material. Alternatively, it may be formed by applying an adhesive or pressure-sensitive adhesive on a metal foil used when forming the electromagnetic wave shielding material and by adhering the metal foil with the adhesive or pressure-sensitive adhesive to a base material.

A plastic film having flexibility is preferable as the base material of the releasable support in the invention. Examples of the plastic film used as the base material include films made of polyesters such as polyethylene terephthalate (PET) and polyethylene naphthalate (PEN), polyolefins such as polyethylene, polypropylene, polystyrene, and an ethylene/vinyl acetate copolymer (EVA), vinyls such as polyvinyl chloride and polyvinylidene chloride, polysulphone, polyethersulphone, polyphenylene sulfide, polycarbonate, polyamide, polyimide, an acylic resin, and a cycloolefin resin. A PET film is preferred from the aspects of cost, transparency, and handling. Because the electromagnetic wave shielding material is required only to be releasable from the releasable support, the film made of materials described above may have been subjected to a releasable treatment such as a silicon treatment. Further, when the adhesive or pressure-sensitive adhesive of active energy ray adhesive force vanishing type described later is used as the first adhesive or pressure-sensitive adhesive, it functions as a pressure-sensitive adhesive layer when the electromagnetic wave shielding material is formed, and releasability can be given by irradiation with an active energy ray after forming the electromagnetic wave shielding material.

A known additive can be added to the base material. Examples of the additive include a light stabilizer, an ultraviolet ray absorbent, and an anti-static agent. Generally, a hindered amine light stabilizer is often used as the light stabilizer that can be added to the base material. Other examples include a hindered phenol light stabilizer, a Ni light stabilizer, and a benzoate light stabilizer. Because they have a synergistic effect and an antagonistic effect with the ultraviolet ray absorbent, they may be combined appropriately. Further, any inorganic or organic ultraviolet ray absorbents can be used as the ultraviolet ray absorbent, and the organic ultraviolet ray absorbent is practical. Any organic ultraviolet ray absorbent is available as long as it has a maximum absorption between 300 to 400 nm and effectively absorbs light in that range. Specific examples thereof include a benzotriazole ultraviolet ray absorbent, a benzophenone ultraviolet absorbent, a salicylic acid ester ultraviolet ray absorbent, an acrylate ultraviolet absorbent, an oxalic acid anilide ultraviolet ray absorbent, and a hindered amine ultraviolet absorbent. They may be used alone, and more preferably they are used in combination of several kinds thereof. Further, stability can be improved by blending the ultraviolet ray absorbent and a hindered amine light stabilizer or an antioxidant.

Further, examples of the antistatic agent include metal compounds such as antimony pentoxide, tin oxide, zinc oxide, and indium oxide, composite metal compounds such as an antimony-containing composite oxide, an In—Sn composite oxide, a phosphorus compound, amine derivatives such as a quaternary ammonium salt and amine oxide, and conductive polymers such as polyaniline.

Furthermore, the base material preferably has heat resistance, etching resistance, acid resistance, and alkaline resistance in the case where a geometric-form electromagnetic wave shielding material is formed by an etching method. In the case of using the pressure-sensitive adhesive of active energy ray adhesive force vanishing type, the base material must be a plastic film that transmits the active energy ray.

The thickness of the base material is preferably about 5 to 500 μm. When it is less than 5 μm, the handling thereof becomes poor, and when it exceeds 500 μm, the flexibility thereof diminishes and the handling thereof becomes poor. The face of the base material on the side where the metal foil is to be pasted may be applied with an easily adhesive treatment in order to enhance adhesiveness with the first adhesive or pressure-sensitive adhesive. Examples of the easily adhesive treatment include a corona discharge treatment, a plasma treatment, a dry treatment such as a frame treatment, and a wet treatment such as a primer treatment.

A known method can be used as a method of forming a geometric-form electromagnetic wave shielding material onto a base material. For example, a method can be used of pasting a metal foil to a base material using a first adhesive or pressure-sensitive adhesive to thereby pattern the metal foil in a geometric form by an etching method. Moreover, examples of the method other than the etching method include a plating method and a printing method using a conductive ink.

Available examples of the metal foil to be pasted to the base material include a foil made of a metal such as copper, aluminum, nickel, iron, gold, silver, stainless steel, tungsten, chromium, and titanium, or a foil made of an alloy obtained by combination of two kinds or more of them. Foils of copper, aluminum, and nickel are preferable in terms of conductivity (electromagnetic wave shielding property), ease of forming a geometric pattern, and cost. A foil made of a paramagnetic metal such as nickel, iron, stainless steel, and titanium is preferable because it is superior in magnetic shielding property.

The thickness of the metal foil is preferably 0.5 to 40 μm. The thickness exceeding 40 μm is not preferable because problems of difficulty in forming fine lines and narrowness of viewing angle may occur. Further, as the surface resistance becomes large when the thickness is less than 0.5 μm, the electromagnetic wave shielding effect tends to deteriorate. From the viewpoint of the wave shielding property, the thickness of 1 to 20 μm is more preferable.

In the case of manufacturing a geometric-form electromagnetic wave shielding material using a metal foil, the metal foil subjected to a blackening treatment in advance may be used or the blackening treatment may be performed after forming the geometric-form electromagnetic wave shielding material in order to improve the contrast of the display. The blackening treatment after the formation is preferable because the blackening treatment can be performed also on the side face of the geometric-form electromagnetic wave shielding material at the same time.

Moreover, the metal foil such as an electrolytic copper foil has an uneven surface, and when the metal foil is pasted to an adhesive or pressure-sensitive adhesive, unevenness originated in the unevenness of the metal foil is transferred on the surface of the adhesive or pressure-sensitive adhesive. In the conventional method, when the metal foil is etched, the unevenness remains on the surface of the adhesive or pressure-sensitive adhesive of an etching opening, and in the case of pasting this foil as an electromagnetic wave shielding material, a small amount of air easily remains on the uneven face, and the remaining air becomes a defect part of the display. Further, foreign matters easily attach to the adhesive or pressure-sensitive adhesive layer, thereby resulting in a defective product due to attachment of, for example, etching residue generated at etching or a fine needle-like metal oxide crystal generated at the blackening treatment of the electromagnetic wave shielding material formed with the metal foil, and there has been a problem that such foreign matters become a cause of decrease in transparency, etc. However, in the production method for the electromagnetic wave shielding laminate in the invention, the problem in the conventional method does not occur because the first adhesive or pressure-sensitive adhesive layer is removed from the electromagnetic wave shielding material when the electromagnetic wave shielding material is separated from the first adhesive or pressure-sensitive adhesive to be transferred. Furthermore, the electromagnetic wave shielding material is formed by etching, for example. Because the base material also passes through various rolls such as a feed roll at this time, fine scratches caused by the feed roll and film deterioration caused by an etchant, etc. may be generated on the plastic film of the base material. However, according to the production method of the invention, the base material is removed when the electromagnetic wave shielding material is transferred onto another support, which eliminates the problem of the defect product caused by scratches on the base material, etc. as described above.

The known adhesive or pressure-sensitive adhesive can be used as the first adhesive or pressure-sensitive adhesive. Examples of such a known adhesive or pressure-sensitive adhesive include adhesives or pressure-sensitive adhesives such as an acrylic resin, an epoxy resin, a urethane resin, a polyester resin, a polyether resin, engineering plastics, super engineering plastics, an urea resin, a melamine resin, a copolymer resin, an acetate resin, a silicon resin, a silca resin, a vinyl acetate resin, a polystyrene rein, a cellulose resin, and a polyolefin resin.

When a pressure-sensitive adhesive of active energy ray adhesive force vanishing type is used as the first adhesive or pressure-sensitive adhesive, an attempt is made to reduce the adhesion force of the adhesive by irradiation with an active energy ray as described above, so that the electromagnetic wave shielding material is easily and clearly released from the releasable support. For this reason, an adhesive of active energy ray adhesive force vanishing type is preferably used as the first adhesive or pressure-sensitive adhesive in the invention. The first adhesive or pressure-sensitive adhesive may be any one as long as it has a smaller adhesion force with the electromagnetic wave shielding material than that of an adhesive or pressure-sensitive adhesive of the transfer support (the second adhesive or pressure-sensitive adhesive) and allows the electromagnetic wave shielding material to be separated from the first adhesive or pressure-sensitive adhesive layer of the releasable support and transferred onto the transfer support. If necessary, a treatment of reducing the adhesion force with the metal foil, etc. may be applied to the surface of the adhesive or pressure-sensitive adhesive.

Although the adhesive force of the adhesive of active energy ray adhesive force vanishing type is reduced by irradiation with an active energy ray, the adhesive is a pressure-sensitive adhesive, and thus can adhere the metal foil to the base material film by applying a pressure. As the adhesive of active energy ray adhesive force vanishing type, preferably used are ones containing an elastic polymer having a reactive functional group, an active energy ray reactive compound, a photopolymerization initiator, and a curing agent can be preferably used. Further, the adhesive of active energy ray adhesive force vanishing type may be blended with a known tackifier resin (such as rosin ester), an inorganic fine particle compound (such as a silica compound with an average particle diameter of 20 μm or less), a polymerization stabilizer (such as hydroquinone), an anti-rust agent, a plasticizer, an ultraviolet ray absorbent, etc.

An acrylic polymer and a urethane polymer are preferable as the elastic polymer having a reactive functional group in the adhesive of active energy ray adhesive force vanishing type, and examples of the reactive functional group include a carboxyl group, a hydroxyl group, an amide group, a glycidyl group, and an isocyanate group.

Typical examples of the acrylic polymer of the elastic polymer having a reactive functional group include (A) a copolymer of a monomer having a reactive functional group and another (meth)acrylic ester monomer and (B) a copolymer of a monomer having a reactive functional group, another (meth)acrylic ester monomer, and another vinyl monomer that is copolymerizable with the monomer. These acrylic polymers are synthesized by a known method. In order to impart adhesiveness, a glass transition point of the acrylic polymer is preferably 10° C. or less. A weight average molecular weight of the acrylic polymer is preferably 200,000 to 2,000,000, and more preferably 400,000 to 1,500,000 in terms of the balance between adhesive force and cohesive force. Further, the weight average molecular weight of the polymer is measured using a calibration curve of standard polystyrenes by gel permeation chromatography.

Examples of the monomer having a reactive functional group that can be used to manufacture the acrylic polymer include acrylic acid, methacrylic acid, itaconic acid, 2-hydroxyethyl acrylate, 2-hydroxyethylmethacrylate, 4-hydroxybutyl acrylate, acrylamide, glycidyl methacrylate, and 2-methacryloyl-oxyethylisocianate.

Examples of the another (meth)acrylic ester monomer include methyl acrylate, methyl methacrylate, ethyl acrylate, ethyl methacrylate, butyl acrylate, butyl methacrylate, isobutyl acrylate, isobutyl methacrylate, isopropyl acrylate, 2-ethylhexyl acrylate, 2-ethylhexyl methacrylate, lauryl acrylate, dimethylaminomethyl methacrylate, and dimethyl-aminoetyl methacrylate.

Examples of the another vinyl monomer that is copolymerizable with the monomer having the reactive functional group and another (meth)acrylic ester monomer include vinyl acetate, styrene, α-methylstyrene, acrylonitrile, and vinyltoluene.

On the other hand, an example of the urethane polymer is a polymer obtained by allowing organic polyisocyanate to react with polyurethane polyol of a terminal hydroxyl group obtained by reaction between polyol and organic polyisocyanate.

Examples of the polyol used in producing the urethane polymer include known polyesterpolyols and polyetherpolyols. Examples of an acid component of polyesterpolyol include a terephthalic acid, adipic acid, and azelaic acid, examples of a glycol component include ethylene glycol, propylene glycol, and diethylene glycol, and examples of a polyol component include glycerin, trimethylolpropane, and pentaerithritol. Further, examples of polyetherpolyol include ones having two or more functional groups such as polypropylene glycol, polyethylene glycol, and polytetramethylene glycol. The weight average molecular weight of polyesterpolyol and polyetherpolyol is preferably 1000 to 5000, and more preferably 2500 to 3500. The reaction is fast so that gelation is easily caused with polyesterpolyol and polyetherpolyol having a weight average molecular weight of 1000 or less, and reactivity decreases and also the cohesion force decreases with polyesterpolyol and polyetherpolyol having a weight average molecular weight of 5000 or more. When the reaction of polyol and organic polycyanate is conducted, multivalent amine may be used together.

Examples of the organic polyisocyanate include known aromatic polyisocyanate, aliphatic polyisocyanate, araliphatic polyisocyanate, and alicyclic polyisocyanate. Examples of the aromatic polyisocyanate include 1,3-phenylene diisocyanate, 4,4-diphenyldiisocyanate, 2,4-tolylene diisocyanate, 2,6-tolylene diisocyanate, and 4,4-diphenylmethane diisocyanate. Examples of aliphatic polyisocyanate include trimethylene diisocyanate, tetramethylene diisocyanate, and hexamethylene diisocyanate. Examples of araliphatic polyisocyanate include ω,ω′-diisocyanate-1,3-dimethylbenzene, ω,ω′-diisocyanate-1,4-dimethylbenzene, and ω,ω′-diisocyanate-1,4-diethylbenzene. Examples of alicyclic polyisocyanate include isophorone diisocyanate, 1,3-cyclopentane diisocyanate, and 1,4-cyclohexane diisocyanate. A trimethylolpropane adduct of the organic polycyanate, a buret reacted with water, and a trimer having an isocyanurate ring, etc. may be used with the organic polyisocyanate.

The weight average molecular weight of the urethane polymer is preferably 5,000 to 300,000, and more preferably 10,000 to 200,000 in terms of the balance between adhesive force and cohesive force.

Examples of the active energy ray reactive compound include known monomers and oligomers that are three-dimensionally crosslinked by irradiation with the active energy ray. And the preferable monomer and oligomer that are three-dimensionally crosslinked by irradiation with the active energy ray have two or more acryloyl groups or methacryloyl groups in a molecule.

Examples of the monomer which is three-dimensionally crosslinked by the irradiation with the active energy include a monomer such as 1,6-hexanediol diacrylate, trimethylolpropane triacrylate, and dipentaerithritol hexacrylate.

Further, an example of the oligomer is a urethane acrylate oligomer. An available example of the urethane acrylate oligomer is one obtained by causing a terminal isocyanate prepolymer obtained by reaction between polyol such as polyesterpolyol and polyetherpolyol and organic polyisocianate such as 2,4-tolylene diisocyanate, 2,6-tolylene diisocyanate, 1,3-xylylene diisocyanate, 1,4-xylylene diisocyanate, and diphenylmethane 4,4-diisocyanate, to react with acrylate or methacrylate having a hydroxyl group such as 2-hydroxyethyl acrylate, 2-hydroxyethyl methacrylate, polyethylene glycol acrylate, polyethylene glycol methacrylate, and pentaerythritol triacrylate. The number average molecular weight of the urethane acrylate oligomer is preferably 500 to 30,000, and more preferably 1,000 to 20,000. The urethane acrylate oligomer preferably has 2 to 15 acryloyl or methacryloyl groups, more preferably 4 to 15 acryloyl or methacryloyl groups, and particularly preferably 6 to 15 acryloyl or methacryloyl groups.

The amount of the active energy ray reactive compound used is preferably 20 to 500 parts by weight, and more preferably 40 to 300 parts by weight with respect to 100 parts by weight of the elastic polymer. When it is less than 20 parts by weight, the decrease of the adhesive force may become insufficient after irradiation with the active energy ray, and when it exceeds 500 parts by weight, contamination due to a non-reacted part may occur.

Examples of the photopolymerization initiator include benzophenone, acetophenone, benzoin, benzoin methyl ether, benzoin ethyl ether, benzoin isopropyl ether, benzoin isobutyl ether, benzoin benzoate, benzoin methylbenzoate, benzoin dimethylketal, acetophenone dimethylketal, 2,4-diethylthioxanson, 1-hydroxycyclohexylphenylketone, benzyldiphenylsulfide, azobisisobutylonitrile, benzyl, dibenzyl, diacetyl, bisimidazole, and β-chloranthraquinone.

In the adhesive of active energy ray adhesive force vanishing type, a photopolymerization initiator and a sensitizer are preferably used together. Examples of the sensitizer include triethanolamine, N-methyldiethanolamine, N,N-dimethylethanolamine, and N-methylmorpholine. However, it is not particularly limited, and any known sensitizer can be used also.

The curing agent imparts a cohesion force to the adhesive by reacting with an elastic polymer having a reactive functional group, and available examples thereof include known multi-functional compounds such as an isocyanate compound, an epoxy compound, and an aziridinyl compound having reactivity with the reactive functional group. The amount of the curing agent used may be determined by considering the types and the adhesive force of the acrylic monomer. Without being limited thereto, the amount of the curing added is preferably 0.1 to 15 parts by weight, and more preferably 0.1 to 10 parts by weight with respect to 100 parts by weight of the acrylic resin. The amount less than 0.1 parts by weight is not preferable because the degree of crosslinking decreases and the cohesion force becomes insufficient, and the amount exceeding 15 parts by weight is not preferable because the adhesive force to the adherend tends to be small.

Examples of the isocyanate compound include diisocyanates such as tolylene diisocyanate, isophoron diisocyanate, hexamethylene diisocyanate, m-phenylene diisocyanate, and xylylene diisocyanate, a trimethylolpropane adduct of these compounds, a buret reacted with water, and a trimer having an isocyanurate ring.

Examples of the epoxy compound include sorbital polyglycidyl ether, polyglycerol polyglycidyl ether, pentaerythritol polyglycidyl ether, diglycerol polyglycidyl ether, glycerol polyglycidyl ether, neopentyl glycol diglycidyl ether, resorcine diglycidyl ether, metaxylene diamine tetraglycidyl ether, and their hydrogenated products.

Examples of the aziridinyl compound include N,N′-diphenylmetane-4,4-bis(1-aziridine carboxyamide), tri-methylolpropane-tri-β-aziridinyl propionate, tetra-methylolmethane-tri-β-aziridinyl propionate, and N,N′-toluene-2,4-bis(1-aziridine carboxyamide)triethylene melamine.

Examples of the method of coating the first adhesive or pressure-sensitive adhesive include a comma coating method, a lip coating method, a curtain coating method, a blade coating method, a gravure coating method, a kiss coating method, a reverse coating method, and a micro-gravure coating method, without being limited thereto.

The thickness of the adhesive of active energy ray adhesive force vanishing type is preferably about 0.5 μm to 50 μm. When the thickness of the adhesive or pressure-sensitive adhesive is less than 0.5 μm, sufficient adhesiveness cannot be obtained, and when it exceeds 50 μm, it is economically disadvantageous.

The active energy ray of the invention means an electromagnetic wave having energy that vanishes the adhesive force with the irradiation, and its examples include an electron beam and an ultraviolet ray. Among these, the ultraviolet ray is preferable from the viewpoints of lower expense and running cost of the device. A known light source can be used for the ultraviolet ray.

Examples of the method of providing the first adhesive or pressure-sensitive adhesive to the support include a method of applying the adhesive or pressure-sensitive adhesive directly onto the support as described above and a method of laminating layers that have been sheeted temporarily. The coating method has been already described. On the other hand, available laminating methods are room temperature lamination, heated lamination, and pressurized lamination. In particular, because a desired performance cannot be obtained when air gets in between the base material film and the adhesive or pressure-sensitive adhesive layer, a vacuum laminating method is preferable in order to avoid such a problem. While, lamination with a roll is preferable from the viewpoint of productivity. Alternatively, the first adhesive or pressure-sensitive adhesive may be provided on the metal foil and the resulting layer may be pasted with the releasable support.

The method of pasting the support provided with the first adhesive or pressure-sensitive adhesive to the metal foil is not particularly limited, and a laminating method such as room temperature lamination, heated lamination, and pressurized lamination can be used. In particular, because a desired performance cannot be obtained when air gets in between the base material film and the first adhesive or pressure-sensitive adhesive, vacuum lamination is preferably performed. In the case of using a separator on the first adhesive or pressure-sensitive adhesive, pasting is made after releasing the separator.

The geometric-form electromagnetic wave shielding material may be prepared by forming a mesh-shaped etching resist pattern using a microlithography method, a screen printing method, and an intaglio offset printing method, etc., and then selectively etching the metal foil using an etchant having corrosiveness to the metal.

Examples of the microlithography method used in the formation of the etching resist pattern include a photolithography method, an x-ray lithography method, an electron beam lithography method, and an ion beam lithography method. Among these, the photolithography method is preferable in terms of its simplicity and easiness and mass production property. Especially, the photolithography method using chemical etching is the most preferable in terms of its simplicity and easiness, economic efficiency, process accuracy of the metal mesh, etc. Any etching resist of a negative type and a positive type can be used in the photolithography method. Any etching resist ink may be used as long as a curing substance has resistivity to a metal etching process, and examples thereof include a photoresist composition, a light-sensitive resin composition, and a thermosetting resin composition.

Any conventionally known method can be used as the method of etching the metal foil, and a chemical etching method is preferable in terms of economic efficiency, etc. The chemical etching method is to dissolve a metal foil other than a part protected by etching resist with an etchant to remove the metal foil. Examples of the etchant include an aqueous ferric chloride solution, an aqueous cupric chloride solution, and an alkaline etchant. Among these, preferable are reusable aqueous solutions of ferric chloride and cupric chloride with low contamination. The concentration of the etchant depends on the thickness of the metal foil and the process speed, but it is normally about 150 to 250 g/liter. The temperature of the liquid is preferably in the range of 40 to 80° C. Examples of a method of exposing the metal foil to the etchant include soaking of the metal foil into the etchant, showering of the etchant onto the metal foil, and exposure of the metal foil into a gas phase of the etchant. The showering of the etchant onto the metal foil is preferable in terms of stability of etching accuracy.

Examples of a unit shape constituting the geometric-form electromagnetic wave shielding material include triangles such as an equilateral triangle, an isosceles triangle, and a right-angled triangle, quadrangles such as a square, a rectangular, arhombus, a parallelogram, and a trapezoid, n-sided polygons (n is a positive number) such as a hexagon, an octagon, a dodecagon, and an icosagon, a circle, an oval, and a star. The shape of the mesh consists of one kind or combination of two kinds or more of the unit shapes described above. For the unit shape constituting the mesh, a triangle is the most effective from the viewpoint of electromagnetic shielding property. Alternatively, the n-sided polygons with a large number n is preferable from the viewpoint of visible light transmittance.

The width of the line configuring the geometric form is preferably in the range of 40 μm or less, the spacing of the lines is preferably in the range of 100 μm or more, and the thickness of the line is preferably in the range of 40 μm or less. From the viewpoint of non-visibility, the line width is more preferably 25 μm or less, and from the viewpoint of the visible light ray transmittance, the line spacing is more preferably 120 μm or more and the line thickness is more preferably 18 μm or less. The line width is preferably 40 μm or less, and particularly preferably 25 μm or less. However, it is preferably 1 μm or more because the surface resistance becomes too large and the shielding effect deteriorates when the line width becomes too small and thin. The thickness of the line is preferably 40 μm or less. However, it is preferably 0.5 μm or more, and more preferably 1 μm or more because the surface resistance becomes too large and the shielding effect deteriorates when the thickness is too small. The opening rate is improved and the visible light transmittance is improved as the line spacing increases. When the electromagnetic wave shielding material is used in the display front face as described above, the opening rate is preferably 50% or more, and more preferably 60% or more. Because the electromagnetic wave shielding property deteriorates when the line spacing becomes too large, the line spacing is preferably 1000 μm (1 mm) or less. The opening rate here is percentage as a ratio of the area obtained by subtracting the area of the electromagnetic wave shielding material from the effective area of the electromagnetic wave shielding material with respect to the effective area.

The surface of the geometric-form electromagnetic wave shielding material can be blackened using a blackening treatment liquid with a method employed in the field of printed wiring boards. The blackening treatment is preferably performed after the etching because the top and side faces of the geometric-form electromagnetic wave shielding material can be subjected to the blackening treatment by performing the blackening treatment after the etching. However, the metal foil before etching may be subjected to the blackening treatment in advance. The blackening treatment may be performed in an aqueous solution of sodium chlorite (31 g/liter), sodium hydroxide (15 g/liter), and trisodium phosphate (12 g/liter) at 95° C. for 2 minutes.

Further, the electromagnetic wave shielding material may be formed by a method other than the above-described etching method, such as a plating method and a printing method. In the printing method, the geometric form can be formed with a conductive material directly on the base material by printing a conductive ink on the releasable support using a flexographic printing method, an intaglio printing method, etc.

In the invention, the geometric-form electromagnetic wave shielding material provided on the releasable support is preferably transferred to a transfer support having a functional layer. At that time, the geometric-form electromagnetic wave shielding material provided on the releasable support is pasted with the transfer support through the second adhesive or pressure-sensitive adhesive. Then, the transfer support is peeled off from the releasable support, and only the geometric-form electromagnetic wave shielding material is separated and transferred to the side of the transfer support, whereby the electromagnetic wave shielding material can be formed on the transfer support.

In the case of using the adhesive of active energy ray adhesive force vanishing type as the first adhesive or adhesive, the adhesion force of the adhesive can be decreased by irradiation with an active energy ray at the same time of or before the separating and transferring. In the step of irradiating with the active energy ray, the irradiation is preferably conducted once or more before, after or at the same time when the geometric-form electromagnetic wave shielding material and the transfer support are pasted through the adhesive or pressure-sensitive adhesive.

The irradiation intensity of the ultraviolet ray is not particularly limited as long as it enables reduction in the adhesive of active energy ray adhesive force vanishing type, but it is preferably 20 to 3,000 mJ/cm², more preferably 50 to 3,000 mJ/cm², and further preferably 100 to 3,000 mJ/cm². When it is less than 20 mJ/cm², curing of the adhesive layer may become insufficient, resulting in insufficient decrease of the adhesive force. When it exceeds 3,000 mJ/cm², the irradiation takes a long time and it is economically disadvantageous, and there is a fear that the base material may be damaged by heat due to the irradiation.

The release strength of the metal foil with the releasable support is not particularly limited as long as it enables an electromagnetic wave shielding material to be formed by etching the metal foil and allows the formed electromagnetic wave shielding material to be separated and transferred onto a transfer support. Description will be given of the case of using the adhesive of active energy ray adhesive force vanishing type as the first adhesive or pressure-sensitive adhesive. It is preferably 100 g/25 mm (90° peel-releasing) or more, and 3000 g/25 mm (90° peel-releasing) or less before irradiation with the active energy ray, and it is preferably less than 30 g/25 mm (90° peel-releasing) after irradiation with the active energy ray. In the case that the release strength before the irradiation with the active energy ray is less than 100 g/25 mm (90° peel-releasing), the base material film may be released from the metal foil in the step of etching, etc. depending on the etching method, the etching condition, and the conveying condition to be used. However, this problem also can be solved by appropriately selecting the process condition, and the present invention can be carried out even when the release strength is less than the release strength. On the other hand, if it exceeds 3000 g/25 mm (90° peel-releasing), the release strength may not sufficiently decrease even when the adhesive or pressure-sensitive adhesive is irradiated with the active energy ray. However, by adjusting the composition, the film thickness, etc. of the adhesive of active energy ray adhesive force vanishing type, a metal foil and a releasable support having the release strength described above or more are not unusable. Further, in the case that the release strength after irradiation with the active energy ray is 30 g/25 mm (90° peel-releasing) or more, the metal mesh, that is the electromagnetic wave shielding material formed by etching, may not be, in some cases, transferred to the transfer support with stability depending on the releasing condition, etc. However, it is not impossible that the metal mesh can be transferred even at the above-described release strength or more, for example, by adjusting the release strength of the second adhesive or bonding agent of the transfer support or by appropriately setting the releasing condition.

Further, the organic substance contamination rate on the electromagnetic wave shielding material after peeling off the releasable support is preferably 50% or less. The organic substance contamination rate here is a value calculated from the existing rate of the metal elements on the surface of the metal foil measured with an ESCA (Electron Spectroscopy for Chemical Analysis). The organic substance contamination rate can be recorded as a percentage of the value obtained by dividing the existing rate of the metal elements on the surface of the untreated metal foil, the value being the denominator, by the existing rate of the metal elements on the surface of the metal foil after peeling off the releasable support (for example, in the case of using the adhesive of active energy ray adhesive force vanishing type, after irradiating with the active energy ray a laminate, which is formed by pasting the base material on one face of the metal foil through the adhesive of active energy ray adhesive force vanishing type), the value being the numerator.

Organic substance rate(%)={(Existing rate of metal elements on surface of metal foil after separation of releasable support)/(Existing rate of metal elements on surface of untreated metal foil)}×100

In the case of a copper foil that is one kind of the metal foil, the existing rate of a copper element on the surface of the untreated copper foil may not be 100% because the surface of copper is immediately oxidized or an anti-rusting agent is applied for the purpose of suppressing oxidation. However, it does not interfere when calculating the organic substance contamination rate.

Moreover, the releasable support is not necessarily released and may be used as a protective film depending on the case.

Known general adhesives can be used as the second adhesive or pressure-sensitive adhesive used in the transfer support. Examples of such an adhesive include an acrylic resin, an epoxy resin, a urethane resin, a polyester resin, a polyether resin, engineering plastics, super engineering plastics, an urea resin, a melamine resin, a copolymer resin, an acetate resin, a silicon resin, a silica resin, a vinyl acetate resin, a polystyrene resin, a cellulose resin, and a polyolefin resin. The surface of the adhesive layer is preferably flat and smooth, as well as having high transparency.

The thickness of the second adhesive or pressure-sensitive adhesive on the transfer supporting is preferably 1 to 500 μm, and more preferably 5 to 300 μm. When it is 1 μm or less, there is a fear that an adhesive force becomes insufficient. On the other hand, when it exceeds 500 μm, the transparency and drying property at the coating may decrease. In order to impart impact resistance and scattering preventing property by the second adhesive or pressure-sensitive adhesive layer, the coated thickness (the dry thickness) is preferably 50 μm or more.

The second adhesive or pressure-sensitive adhesive of an acrylic resin is preferably constituted normally with an acrylic polymer obtained by copolymerizing known acrylic monomers and a curing agent added in order to secure the cohesive force and give heat resistance, weather resistance, etc. An adhesive using a urethane polymer is also preferable.

Preferable examples of the acrylic polymer include an acrylic polymer having at least one kind of reactive functional group consisting of a carboxyl group, a hydroxyl group, an amide group, a glycidyl group, an amino group, and an acetoacetoxy group in a molecule. Examples of the acrylic polymer include (C) a copolymer of a monomer having a reactive functional group and another (meth)acrylic ester monomer and (D) a copolymer of a monomer having a reactive functional group, another (meth)acrylic ester monomer, and another vinyl monomer that is copolymerizable with the monomers. In order to impart adhesiveness, a glass transition point of the acrylic polymer is preferably −20° C. or less. A weight average molecular weight of the acrylic polymer is preferably 200,000 to 2,000,000, and more preferably 400,000 to 1,500,000 in terms of the balance between adhesive force and cohesive force. Examples of the monomer used for manufacturing the acrylic polymer are given below, but not limited thereto. Any known monomer conventionally used for manufacturing an acrylic polymer can be used. Moreover, the weight average molecular weight of the polymer is measured using a calibration curve by standard polystyrenes with gel permeation chromatography.

Examples of the monomer having a reactive functional group that can be used for manufacturing the acrylic polymer include acrylic acid, methacrylic acid, itaconic acid, 2-hydroxyethyl acrylate, 2-hydroxyethylmethacrylate, 4-hydroxybutylacrylate, 2-acetoacetoxyethyl methacrylate, acrylamide, glycidyl methacrylate, and 2-methacryloyloxyethyl isocyanate.

Examples of the another (meth)acrylic ester monomer include methyl acrylate, methyl methacrylate, ethyl acrylate, ethyl methacrylate, butyl acrylate, butyl methacrylate, isobutyl acrylate, isobutyl methacrylate, isopropyl acrylate, 2-ethylhexyl acrylate, 2-ethylhexyl methacrylate, lauryl acrylate, dimethylaminomethyl methacrylate, and dimethlaminoethyl methacrylate.

Further, examples of the another vinyl monomer that is copolymerizable with the monomer having the reactive functional group and another (meth)acrylic ester monomer include vinyl acetate, styrene, α-methylstyrene, acrylonitrile, and vinyltoluene.

On the other hand, examples of the curing agent include a known multi-functional compound having reactivity to the reactive functional group, such as a isocyanate compound, an epoxy compound, and an aziridinyl compound. The amount of the curing agent to be used may be determined by considering the types and the adhesive force of the acrylic monomer, and is not particularly limited. The curing agent is preferably added in an amount of 0.01 to 40 parts by weight, and more preferably 0.1 to 10 parts by weight with respect to 100 parts by weight of an acrylic resin. The amount of less than 0.01 parts by weight is not preferable because the degree of crosslinking decreases and the cohesive force become insufficient. The amount exceeding 15 parts by weight is not preferable because the adhesive force to the adherend tends to become small. Therefore the amount the curing agent added is preferably 0.1 to 15 parts by weight, and more preferably 0.1 to 10 parts by weight. The amount of less than 0.1 parts by weight is not preferable because the degree of crosslinking decreases and the cohesive force become insufficient. The amount exceeding 15 parts by weight is not preferable because the adhesive force to the adherend tends to become small.

Examples of the isocyanate compound include diisocyanate such as tolylene diisocyanate, isophoron diisocyanate, hexamethylene diisocyanate, m-phenylene diisocyanate, and xylylene diisocyanate, a trimethylolpropane adduct of these compounds, a buret compound of these compounds reacted with water, and a trimer having an isocyanurate ring.

Examples of the epoxy compound include sorbital polyglycidyl ether, polyglycerol polyglycidyl ether, pentaerythritol polyglycidyl ether, diglycerol polyglycidyl ether, glycerol polyglycidyl ether, neopentyl glycol diglycidyl ether, resorcine diglycidyl ether, metaxylene diamine tetraglycidyl ether, and products obtained by adding water thereto.

Examples of the aziridinyl compound include N,N′-diphenylmetane-4,4-bis(1-aziridine carboxyamide), trimethylolpropane-tri-β-aziridinyl propionate, tetramethylolmethane-tri-β-aziridinyl propionate, and N,N′-toluene-2,4-bis(1-aziridine carboxyamide)triethylene melamine.

Also preferably used is an adhesive of active energy ray adhesive force vanishing type in which an active energy ray reactive compound and a photopolymerization initiator are compounded instead of the curing agent. In addition, a polymerization inhibitor and other additives are added to the adhesive of active energy ray adhesive force vanishing type depending on necessity.

Examples of the active energy ray reactive compound include known monomers and oligomers that are three-dimensionally crosslinked by irradiation with the active energy ray. They have two or more acryloyl groups or methacryloyl groups in a molecule. The active energy ray reactive compound is preferably compounded in an amount of 0.1 to 50 parts by weight, more preferably 0.1 to 40 parts by weight, and particularly preferably 0.1 to 20 parts by weight, with respect to 100 parts by weight of the acrylic polymer. When it is less than 0.1 parts by weight, the three-dimensional crosslinking by the irradiation with the active energy ray becomes insufficient, which fails to obtain a necessary cohesive force. When it exceeds 50 parts by weight, the three-dimensional crosslinking by the irradiation with the active energy ray becomes excessive, and no necessary adhesive force may be obtained.

Examples of the monomer which is three-dimensionally crosslinked by irradiation with the active energy ray include a monomer such as 1,6-hexanediol diacrylate, trimethylolpropane triacrylate, and dipentaerithritol hexacrylate, but the monomer is not limited thereto. In order to adjust viscosity, the degree of crosslinking, etc., a monomer having at least one of acryloyl group or methacryloyl group in a molecule may be added as the active energy ray reactive compound.

Further, any of known oligomers used as an active energy ray reactive compound can be used as the oligomer that is three-dimensionally crosslinked by the irradiation with the active energy ray. A representative example thereof is a urethane acrylate oligomer, but it is not limited thereto. In order to prevent yellowing with passage of time when used as an adhesive, a urethane acrylate oligomer that does not contain aromatic isocyanate such as tolylene diisocyanate as a raw material is preferably used.

Examples of the photopolymerization initiator include benzophenone, acetophenone, benzoin, benzoin methyl ether, benzoin ethyl ether, benzoin isopropyl ether, benzoin isobutyl ether, benzoin benzoic acid, benzoin methylbenzoate, benzoin dimethylketal, acetophenone dimethylketal, 2,4-diethyloxanthone, 1-hydroxycyclohexylphenyl ketone, benzyldiphenylsulfide, azobisisobutylonitrile, benzyl, dibenzyl, diacetyl, bisimidazole, and β-chloroanthraquinone, but not limited thereto. Any of known photopolymerization initiators can be used in the invention.

In the adhesive of active energy ray curing type of the invention, a photopolymerization initiator and a sensitizer are preferably used together. Examples of the sensitizer include triethanolamine, N-methyldiethanolamine, N,N-dimethylethanolamine, and N-methylmorpholine, but not limited thereto, and any known sensitizer can be used.

Any conventionally known compounds used as a polymerization inhibitor can be used as the polymerization inhibitor used in the adhesive of active energy ray curing type. Specific examples of the polymerization inhibitor include a hydroquinone compound such as hydroquinone, methoquinone, methylhydroquinone, parabenzoquinone, toluquinone, t-butylhydroquinone, t-butylbenzoquinone, and 2,5-diphenyl-parabenzoquinone, a phenothiadine compound, and a nitrosamine compound. However, the polymerization inhibitor is not limited to these exemplified compounds.

Examples of the other additives are the same additives as those previously given as the additives of the adhesive. The amount of these additives added is not particularly limited as long as it enables the objective physical properties to be obtained.

The adhesive of active energy ray adhesive curing type is irradiated with the active energy ray so that the active energy ray reactive compound is three-dimensionally crosslinked to give an appropriate cohesive force to the adhesive layer, and thus, the adhesive force appears. The active energy ray reactive compound is preferably compounded at 0.1 to 40 parts by weight, more preferably 0.1 to 30 parts by weight, and particularly preferably 0.1 to 20 parts by weight with respect to 100 parts by weight of the acrylic polymer. When it is less than 0.1 parts by weight, the three-dimensional crosslinking by the irradiation with the active energy ray becomes insufficient, thereby failing to obtain the required cohesive force. When it exceeds 40 parts by weight, the three-dimensional crosslinking by the irradiation with the active energy ray becomes excessive, and the required cohesive force may be obtained.

On the other hand, the second urethane resin adhesive or pressure-sensitive adhesive is constituted with a urethane resin obtained by reaction between known polyol and organic polyisocyanate. The urethane resin may be one obtained by reacting polyol and polyprotic acid or its anhydride, followed by reacting it with an organic polyisocyanate.

Available known polyols include one kind or more of high molecular weight polyol, bisphenols such as bisphenol A and bisphenol F, glycols obtained by addition of an alkylene oxide such as ethylene oxide and propylene oxide to bisphenol, and other polyols. Furthermore, usable are compounds having two or more of hydroxyl groups, obtained by reaction of one kind or more of these with other compounds such as olefin and aromatic hydrocarbon.

An organic polycyanate exemplified as a raw material of the urethane polymer constituting the adhesive of active energy ray curing type can be used as the organic polycyanate.

A curing agent is preferably used for the second urethane polymer adhesive or pressure-sensitive adhesive. An available curing agent is an isocyanate curing agent exemplified as the curing agent constituting the adhesive of active energy ray curing type. The amount of the curing agent used may be determined by considering the type of the urethane resin and the adhesive force. Without being limited thereto, the curing agent is preferably added at 0.1 to 15 parts by weight, and more preferably 0.1 to 10 parts by weight with respect to 100 parts by weight of the urethane resin. The amount less than 0.1 parts by weight is not preferable because the degree of the crosslinking decreases and the cohesive force becomes insufficient, and the amount exceeding 15 parts by weight is not preferable because the adhesive force to the adherend tends to be small.

The second adhesive or pressure-sensitive adhesive may contain various known additives such as a tackifier, a plasticizer, a thickener, an antioxidant, an ultraviolet ray absorbent, various stabilizers, a wetting agent, various medicines, a filler, a pigment, a dye, a diluent, and a curing promoting agent. These additives may be used singly or in combination of two kinds or more thereof. The amount of the additive added is not particularly limited as long as it enables the objective physical properties to be obtained.

Available examples of the tackifier include a terpene resin, an aliphatic petroleum resin, an aromatic petroleum resin, a coumarone-indene resin, a phenol resin, a terpene-phenol resin, and a rosin derivative (such as rosin, polymerized rosin, hydrogenated rosin, ester of these with glycerin, pentaerithrithol, etc., and a resin acid dimer).

An infrared ray absorbing material may be added to the second adhesive or pressure-sensitive adhesive for the purpose of attenuating the infrared rays. Examples of the infrared ray absorbing material include a metal oxide such as iron oxide, cerium oxide, tin oxide, antimony oxide, and indium-tin oxide (ITO), tungsten pentachloride, tin chloride, cupric sulfide, a chromium-cobalt complex, a thiol-nickel complex, and anthraquinone.

The second adhesive or pressure-sensitive adhesive may contain a material having functions such as a near infrared ray absorbing function, a color correcting function, an ultraviolet ray absorbing function, an anti-scattering function, a shock relieving function, and a Ne cutting function. Particularly, when used for a plasma display, the second adhesive or pressure-sensitive adhesive preferably contains a near infrared ray absorbent. As a front face filter for a plasma display, there are often required an electromagnetic wave shielding function, a near infrared ray absorbing function, a color correcting function, an anti-static function, a hard coat function, an antireflection function, etc. Because layers having a hard coat function and an antireflection function are provided near the forefront face, a layer having a near infrared ray absorbing function is provided as a lower layer than the layers having functions described above.

Many materials with a near infrared ray absorbing property (a near infrared absorbent) comprise coloring matters, and also are weak against an ultraviolet ray. An ultraviolet ray curing type matrix is often used in forming the layer giving the hard coat function, anti-reflection function, etc. When the hard coat function layer or the anti-reflection function layer is provided after forming a layer containing a near infrared ray absorbent, the near infrared ray absorbent deteriorates. In the invention, as described after, when a method is employed, in which an electromagnetic wave shielding material is transferred onto a transfer support having a plurality of functional layers formed in advance in order to form an electromagnetic wave shielding layer, the deterioration of a near infrared ray absorbent is prevented by allowing to contain the near infrared ray absorbent in the second adhesive or pressure-sensitive adhesive.

The near infrared ray absorbent is required only to have high transmittance in the wavelength range of 400 to 800 nm and low transmittance in the wavelength range of 800 to 1200 nm. For such a near infrared ray absorbent it is only required to have the necessary near infrared ray absorbing function. It may be selected appropriately by considering compatibility with the adhesive or pressure-sensitive adhesive, and in the case of using a plurality of near infrared ray absorbents, compatibility between absorbents used, and compatibility with a solvent, etc. Further it is preferable that the near infrared ray absorbent has an extremely small light absorptance in the visible light range, absorbs the near infrared ray range as much as possible, is superior in a property forming a coated film, and has high light resistance, heat resistance, humidity resistance, and aging stability of the coating.

Examples of the near infrared ray absorbent include a diimmonium compound, a phthalocyanine compound, a dithiol metal complex compound, a cyanine compound, a metal complex compound, metal fine powder, and metal oxide fine powder, and combinations including resins are universal. The materials may be appropriately used by making sure of a synergistic effect and an antagonistic effect.

As the diimmonium compound having a near infrared ray function, there are exemplified compounds represented by Formula (I) described below as preferable compound. The compounds represented by Formula (1) have a high cutting property for the light of wavelength out of a near infrared range, cut a near infrared ray in a wide range, and have high transmittance for visible light.

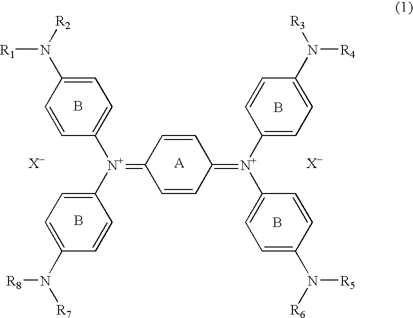

In Formula (1), R₁ to R₈ may be the same or different from each other, and represent a hydrogen atom, an alkyl group that may be substituted, a halogenated alkyl group that may be substituted, a cyanoalkyl group that may be substituted, an aryl group that may be substituted, an alkenyl group that may be substituted, an aralkyl group that may be substituted, an alkynyl group that may be substituted, a hydroxyl group, a phenyl group that may be substituted or a phenylalkenyl group that may be substituted. Further the rings A and B may have a substituent.

In R₁ to R₈, examples of the halogen atom include a fluorine atom, a chlorine atom, and a bromine atom; examples of the alkyl group include as a methyl group, an ethyl group, an n-propyl group, an isopropyl group, an n-butyl group, an isobutyl group, a t-butyl group, an n-amyl group, an n-hexyl group, an n-octyl group, a 2-hydroxyethyl group, a 2-cyanoethyl group, a 3-hydroxy propyl group, a 3-cyanopropyl group, a methoxethyl group, an ethoxyethyl group, and a butoxyethyl group; examples of the alkoxy group include a methoxy group, an ethoxy group, a propoxy group, and butoxy group; examples of the aryl group include a phenyl group, a fluorophenyl group, a chlorophenyl group, a tolyl group, a diethylaminophenyl group, and a naphthyl group; examples of the aralkyl group include a benzyl group, a p-fluorobenzyl group, a p-chlorophenyl group, a phenylpropyl group, and a naphtylethyl group; and examples of the amino group include a dimethylamino group, diethylamino group, a dipropylamino group, and a dibutylamino group as preferable examples.

Furthermore, examples of X⁻ include a fluorine ion, a chlorine ion, a bromine ion, an iodine ion, a perchlorate ion, a hexafluoroantimonic acid ion, a hexafluorophosphoric acid ion, a tetrafluoroboric acid ion, a tetraphenylboric acid ion shown in Formula (2) below (the ring C may have a substituent), and sulfoneimide shown in Formula (3) below (R₁₃ and R₁₄ may be the same or different from each other, and each represents a fluoroalkyl group or a fluoroalkylene group formed by them in combination), but not limited thereto in the invention. Some of them are commercially available, and for example, KayasorbIRG-068 manufactured by Nippon Kayaku Co., Ltd., CIR-RL manufactured by Japan Carlit Co., Ltd., etc. are preferably used.

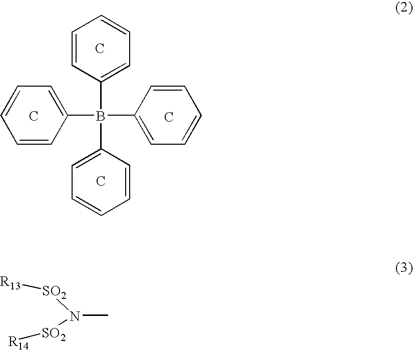

The compound shown in Formula (4), etc. can be preferably used as the dithiol compound.

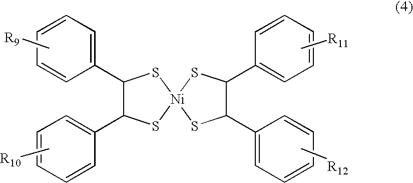

Specific examples of R⁹ to R¹² in the above Formula (4) include a halogen atom such as fluorine, chlorine, and bromine; an alkyl group such as a methyl group, an ethyl group, an n-propyl group, an iso-propyl group, an n-butyl group, an iso-butyl group, a t-butyl group, an n-amyl group, an n-hexyl group, an n-octyl group, a 2-hydroxyethyl group, a 2-cyanoethyl group, a 3-hydroxypropyl group, a 3-cyanopropyl group, a methoxyethyl group, an ethoxyethyl group, and a butoxyethyl group; an alkoxy group such as a methoxy group, an ethoxy group, a propoxy group, and a butoxy group; an aryl group such as a phenyl group, a fluorophenyl group, a chlorophenyl group, a tolyl group, a diethylaminophenyl group, and a naphthyl group; an aralkyl group such as a benzyl group, a p-fluorobenzyl group, a p-chlorophenyl group, a phenylpropyl group, and a naphthylethyl group; and an amino group such as a dimethylamino group, a diethylamino group, a dipropylamino group, and a dibutylamino group. Preferable examples of commercially available products include MIR-101 manufactured by Midori Kagaku Co., Ltd.

As the phthalocyanine compound, preferably used are EXcolor IR-1, EXcolor IR-2, EXcolor IR-3, EXcolor IR-4, TXEX-805K, TXEX-809K, TXEX-810K, TXEX-811K, and TXEX-812K manufactured by Nippon Shokubai Co., Ltd. described above are some examples among many, and the compound usable as the near infrared ray shielding agent is not limited to these.

As the cyanine compound that is a near infrared ray absorbent, preferably usable are CY17 manufactured by Nippon Kayaku Co., Ltd., SD50 manufactured by Sumitomo Seika Chemicals Co., Ltd., and NK-5706 manufactured by Hayashibara Biochemical Lab., Inc.

It is noted that near infrared ray absorbents (near infrared ray shielding agent) described above are some examples of each near infrared ray absorbent that can be used in the invention, and the near infrared ray absorbent that can be used in the invention is not limited to those described above.

Any of inorganic and organic ultraviolet ray absorbents can be used as the ultraviolet ray absorbent, and the organic ultraviolet ray absorbent is practical. The organic ultraviolet ray absorbent preferably has a maximum absorption between 300 to 400 nm and absorbs effectively light in that region. Examples thereof include a benzotriazole ultraviolet ray absorbent, a benzophenone ultraviolet ray absorbent, a salicyclic acid ester ultraviolet ray absorbent, an acrylate ultraviolet absorbent, an oxalic acid anilide ultraviolet ray absorbent, and a hindered amine ultraviolet ray absorbent. These may be used singly, and preferably are used in combination of several kinds thereof. Further, stability can be improved by blending the ultraviolet ray absorbent and a hindered amine light stabilizer or an antioxidant.

The color correcting function is a function to correct the color balance of colors displayed on a display, and for example, cuts orange light with a wavelength 580 to 610 nm emitted from neon, etc. (having Ne cutting function) in a plasma display. Examples of the color correcting agent include, but not limited thereto, coloring matters such as cyanine (polymethine), quinone, azo, indigo, polyene, spiro, porphyrin, phthalocyanine, naphthalocyanine, and cyanine. Cyanine, porphyrin, pyrromethene, etc. can be used for the purpose of cutting orange light with a wavelength 580 to 610 nm emitted from neon etc. in a plasma display.

The transfer support of the invention may preferably have one or more of laminated functional layers having at least one function on one face or both faces thereof.

Examples of the transfer support include a plastic film and a glass plate, and the plastic film is preferred from the viewpoints of costs and easiness of handling as well as high transparency. Specific examples thereof include films made of polyester, acrylic, triacetylcellulose, polyethylene, polypropylene, polyolefin, polycycloolefin, polyvinylchloride, polycarbonate, phenol, and urethane resins, etc. and a so-called easily adhesive type film having a resin layer made of, for example, a styrene-maleic acid graft polyester resin and an acrylic graft polyester resin. A polyester film is preferable from the viewpoints of physical characteristics, optical characteristics, chemical resistance, environmental load, etc. More specifically, a polyethylene terephthalate film (hereinafter, referred to as PET film also) is preferred. When a plastic film containing ultraviolet ray absorbent by kneading etc. is used as a base material, it can be used as a substitute of the ultraviolet ray absorbent layer.

The functional layer is a layer which has one or more functions of conductivity, antireflection property, reflection decreasing property, hard coat property, anti-glare property, anti-fouling function, near infrared ray absorbing function, ultraviolet ray absorbing function, color correcting function, radiating function, shock relieving function, Ne cutting function, and anti-scattering function. It may have functions other than above. In the invention, as the electromagnetic wave shielding material is provided on the transfer support having the functional layer formed in advance, both the electromagnetic wave shielding material and the functional layer can be formed on one support (base material). Thus, a laminate excellent in transparency, light weight etc. can be obtained, which is preferable because of low haze. Particularly, when the functional layer is multi-layered with two or more layers, it may have an especially beneficial effect compared with the conventional method, wherein functional layers having a support for every functional layer are pasted upon each other. Moreover, one or more base materials having the functional layer formed separately may be further laminated through a pressure-sensitive adhesive layer.

When two or more functional layers are formed, these functional layers may be laminated only on one face of the transfer support, or may be laminated separately on both faces. Also, the same functional layer may be provided on both faces. In the case that the functional layers are laminated only on one face of the transfer support, the electromagnetic wave shielding material may be transferred to any face where the functional layers are laminated or where the functional layers are not laminated. Further, the functional layer may be laminated further after the electromagnetic wave shielding material is transferred.

The functional layers having each function described above will be explained specifically below. First, a layer having a hard coat function is a layer to prevent scratching on the surface of a plasma display, and can be made of a resin of ultraviolet ray curing type, electron beam curing type, thermosetting type or the like. The composition and the production method of these resins are not particularly limited, and any of conventionally known resins and production methods is available in the invention. The hard coat layer can be made of a coating agent comprising as the main components, for example, various (meth)acrylates, a photopolymerization initiator, and as necessary, an organic solvent. Preferable examples of the various (meth)acrylates include (meth)acrylates such as polyurethane (meth)acrylate and epoxy (meth)acrylates and other multi-functional (meth)acrylates.

The epoxy (meth)acrylate used when forming the hard coat layer is one formed by esterifying an epoxy group of an epoxy resin with (meth)acrylic acid to change the functional group to a (meth)acryloyl group. Examples thereof include a (meth)acrylic acid additive to a bisphenol A type epoxy resin and a (meth)acrylic acid additive to a novolak type epoxy resin.

The urethane (meth)acrylate can be obtained, for example, by reaction of an isocyanate group-containing urethane prepolymer obtained by reaction between a polyol and a polyisocyanate under a condition of excess isocyanate groups with a (meth)acrylate having a hydroxyl group. Alternatively, it can be obtained by reaction of a hydroxyl group-containing urethane prepolymer obtained by reaction between a polyol and a polyisocyanate under a condition of excess hydroxyl groups with a (meth)acrylate having an isocyanate group.

Examples of the polyol used to form the urethane (meth)acrylate include ethylene glycol, propylene glycol, diethylene glycol, dipropylene glycol, butylene glycol, 1,6-hexanediol, 3-methyl-1,5-pentane glycol, neopentylglycol, hexanetriol, trimethylolpropane, polytetramethylene glycol, and a polycondensate of adipic acid and ethylene glycol.

On the other hand, examples of the polyisocyanate include tolylene diisocyanate, isophoron diisocyanate, and hexamethylene diisocyanate.

Examples of the (meth)acrylate having a hydroxyl group include 2-hydroxyethyl acrylate, 2-hydroxypropyl acrylate, 4-hydroxybutyl acrylate, pentaerythritol triacrylate, and dipentaerythritol pentaacrylate.

Examples of the (meth)acrylate having an isocyanate group include 2-methacryloyloxyethyl isocyanate and methacryloyl isocyanate.

Other multi-functional (meth)acrylates are those having two or more (meth)acryloyl groups in a molecule, and preferably having three or more acryloyl groups in a molecule. Specific examples thereof include trimethylolpropane triacrylate, ethyleneoxide modified trimethylolpropane triacrylate, propyleneoxide modified trimethylolpropane triacrylate, tris(acryloyloxyethyl)isocyanurate, caprolactone modified tris(acryloyloxyethyl)isocyanurate, pentaerythritol triacrylate, pentaerythritol tetraacrylate, ditrimethylolpropane tetraacrylate, dipentaerythritol tetraacrylate, dipentaerythritol hexaacrylate, alkyl modified dipentaerythritol triacrylate, alkyl modified dipentaerythritol pentaacrylate, caprolactone modified dipentaerythritol hexaacrylate, and mixtures of two or more kinds thereof.

Examples of the photopolymerization initiator include benzoin methyl ether, benzoin ethyl ether, benzoin isopropyl ether, benzoin butyl ether, diethoxyacetophenone, benzyl dimethyl ketal, 2-hydroxy-2-methylpropiophenone, 1-hydroxycyclohexylphenyl ketone, benzophenone, 2,4,6-trimethylbenzoindiphenylphosphine oxide, Michler's ketone, isoamyl N,N-dimethylaminobenzoate, 2-chlorothioxanthone, and 2,4-diethylthioxanthone, and two or more kinds of these photopolymerization initiators may be appropriately used together.

Examples of the organic solvent include aromatic hydrocarbons such as toluene and xylene; esters such as ethyl acetate, n-propyl acetate, iso-propyl acetate, n-butyl acetate, and iso-butyl acetate; alcohols such as methyl alcohol, ethyl alcohol, n-propyl alcohol, iso-propyl alcohol, and n-butyl alcohol; ketones such as acetone, methyl ethyl ketone, methyl isobutyl ketone, and cyclohexanone; ethers such as 2-methoxyethanol, 2-ethoxyethanol, 2-butoxyethanol, ethylene glycol dimethyl ether, ethylene glycol diethyl ether, diethylene glycol dimethyl ether, and propylene glycol methyl ether; ether-esters such as 2-methoxyethyl acetate, 2-ethoxyethyl acetate, 2-butoxyethyl acetate, and propylene glycol methyl ether acetate, and two kinds or more of these can be mixed for use.

In addition, a colloidal metal oxide or silica sol using an organic solvent as a dispersion medium may be added to the hard coat layer other than the above-described components in order to improve wear resistance.

The hard coat layer is formed by applying a coating liquid containing the above-described resin and drying the coating film to crosslink and cure the coating agent. Examples of the coating method include a bar coating method, a blade coating method, a spin coating method, a reverse coating method, a die coating method, a spray coating method, a roll coating method, a gravure coating method, a lip coating method, an air-knife coating method, and a dipping method. Crosslinking and curing can be performed by irradiation with an active energy ray if it is an active energy ray curing type of an ultraviolet ray, an electron beam, etc.

Available examples of the active energy ray include an ultraviolet ray emitted from a light source such as a xenon lamp, a low pressure mercury lamp, a high pressure mercury lamp, a super high pressure mercury lamp, a metal halide lamp, a carbon arc lamp, and a tungsten lamp, and an electron beam, an α ray, a β ray, and a γ ray taken out normally from an electron beam accelerator of 20 to 2000 keV. The thickness of the scratch preventing layer formed in this way is normally 1 to 50 μm, and preferably 3 to 20 μm.

The layer having an antireflective function or a reflection decreasing function is a layer formed to prevent surface reflection and increase visible light ray transmittance, and can be selected an arbitrary processing method as the forming method, thus being not limited particularly. In order to impart an antireflection function or reflection decreasing function, there is exemplified a method of forming a thin low refractive index layer or a multi-layered thin films with different refractive indexes on one face or both faces of a support to decrease reflectance by the interference of reflected light at the surface of the thin film and refracted or reflected light at the interface as a general method.

A single optical layer or a combination of optical layers can be used as the antireflective layer or the layer having a reflection decreasing function. Specific examples of the layer configuration include a single low refractive index layer with a refractive index of 1.2 to 1.45, a combination in which a high refractive index layer with a refractive index of 1.7 to 2.4 and the low refractive index layer are alternatively arranged, and a combination of a medium refractive index layer with a refractive index of 1.5 to 1.9, a high refractive index layer with a refractive index of 1.7 to 2.4, and the low refractive index layer.

For the low refractive index layer, usable are a metal compound such as MgF₂ (refractive index: about 1.4), SiO₂ (refractive index: about 1.2 to about 1.5), and LiF (refractive index: about 1.4) and a composite metal compound such as 3NaF.AlF₃ (refractive index: about 1.4) and Na₃AlF₆ (refractive index: about 1.33). Further, for the medium refractive index layer, usable are a metal compound such as Al₂O₃ (refractive index: about 1.65) and MgO (refractive index: about 1.63) and a composite metal compound such as an Al—Zr composite oxide (refractive index: about 1.7 to about 1.85). Furthermore, for the high refractive index layer, usable are a metal compound such as TiO₂ (refractive index: about 2.3), ZrO₂ (refractive index: about 2.05), Nb₂O₅ (refractive index: about 2.25), Ta₂O₅ (refractive index: about 2.15), and CeO (refractive index: about 2.15) and a composite metal compound such as an In—Sn-composite oxide (refractive index: about 1.7 to about 1.85).

These optical layers can be formed using a known method such as a vacuum vapor deposition method, a sputtering method, a chemical vapor deposition method (CVD method), a reactive sputtering method, an ion plating method, and an electroplating method.

The optical layer may be formed using a material prepared by dispersing particles composed of the metal compounds or composite metal compounds described above in a matrix. For example, as the low refractive index layer, a material is usable that is obtained by dispersing low refractive index fine particles of MgF₂, SiO₂, or the like. in an ultraviolet ray curing resin or an electron beam curing resin or a matrix of silicon alkoxide. The low refractive index fine particles are preferably porous because the refractive index becomes lower. In the case that the low refractive index layer is formed by the aforementioned ultraviolet ray or electron beam curing resin matrix containing the low refractive index fine particles, the matrix containing low refractive index fine particles is applied so that the film thickness becomes 0.01 to 1 μm, and as necessary, a drying treatment, an ultraviolet ray irradiation treatment or an electron beam irradiation treatment is performed.

When the optical layer is formed using particles and a matrix, known methods can be used as a coating method. Examples thereof include a method using a rod or wire bar and various coating methods such as a micro gravure coating method, a gravure coating method, a die coating method, a curtain coating method, a lip coating method, and a slot coating method.

The layer having an anti-glare function decreases visual reflectance by reflecting diffusely an outer light to prevent glare. An example thereof is a layer containing a resin binder and fine particles. The fine particles may be, for example, fine particles of silicon dioxide, an acrylic resin, a urethane resin, a melamine resin or the like, which have a particle diameter of about 0.1 to about 10 μm. On the other hand, an acrylic resin etc. can be used as the resin binder. This layer may be formed by applying a coating liquid containing a resin, particles, a solvent, etc. A known method can be used as the coating method, and examples thereof include a method using a rod or wire bar and various coating methods such as a micro gravure coating method, a gravure coating method, a die coating method, a curtain coating method, a lip coating method, and a slot coating method. Further, the layer having an anti-glare function may also be formed by performing an embossing treatment to the resin binder layer not using the method using fine particles described above.

Moreover, to the hard coat layer, a further function of the anti-glare functional layer by mixing the fine particles into the hard coat layer or by performing the embossing treatment on the surface of the hard coat layer may be imparted.

A layer having conductivity, that is, a layer having an anti-static function may be formed using any known materials used to constitute a layer having an anti-static function conventionally. An example of the materials is a material prepared by mixing a conductive anti-static agent into a resin or silica binder. A preferred example of the resin binder is an acrylic resin. On the other hand, an example of the silica binder is a material obtained by hydrolyzing a silicon alkoxide or organic silicon alkoxide represented by RₓSi(OR)_{y}.

Examples of the conductive antistatic agent include metal compounds such as antimony pentoxide, tin oxide, zinc oxide, and indium oxide, composite metal compounds such as an antimony-containing composite oxide, an In—Sn composite oxide, and a phosphorus compound, amine derivatives such as a quaternary ammonium salt and amine oxide, and conductive polymers such as polyaniline.

The antistatic layer may be formed by applying a coating liquid containing the materials described above. A known method can be used as the coating method, and examples thereof include a method using a rod or wire bar, various coating methods such as a micro gravure coating method, a gravure coating method, a die coating method, a curtain coating method, a lip coating method, and a slot coating method, a calendar coating method, and a cast coating method.

By mixing these antistatic materials into the hard coat layer or anti-glare layer, a function as the anti-static layer may be further imparted to these layers.

The layer having an anti-fouling function is a layer used for preventing contamination on the surface, and is to be provided on the foremost surface. The anti-fouling layer can be formed by a gas phase method such as a vapor deposition method and a chemical vapor deposition method (CVD method) using anti-fouling materials such as a fluorine compound, a silicon compound, and a fluorine containing silicon compound. The anti-fouling layer can also be formed with a dipping method, a coating method using a rod or wire bar, various coating methods such as a micro gravure coating method, a gravure coating method, a die coating method, a curtain coating method, a lip coating method, and a slot coating method, a calendar coating method, and a cast coating method, by use of the above-described materials dissolved into a solvent with a binder if necessary.

Further, these materials may be compounded into other functional layer constituting the foremost surface layer to thereby give also an anti-fouling function to the functional layers constituting the foremost surface layer. For example, an anti-fouling function may be imparted to these layers by blending them into a binder of the antireflective layer or the anti-glare layer.

The layer having a near infrared ray absorbing function has a layer with low transmittance in the wavelength region of 800 to 1200 nm, and preferably has high transmittance in wavelength region of 400 to 800 nm. As the near infrared ray absorbing layer, there can be used, for example, a layer obtained by blending a coloring matter, a pigment, etc. having near infrared ray absorbing property into a resin binder, and a thin film made of a near infrared ray absorbing substance such as an In—Sn composite oxide. Examples of such a material with near infrared ray absorbing property (a near infrared absorbent) include a diimmonium compound, a phthalocyanine compound, a dithiol metal complex compound, a cyanine compound, a metal complex compound, metal fine powder, and metal oxide fine powder. The combination of these near infrared absorbents and the combination of the resins and the near infrared absorbents are universal, and they may be appropriately used by making sure of a synergistic effect and an antagonistic effect.

A preferable example of the diimmonium compound having near infrared ray absorbing function is a compound, for example, represented by the aforementioned Formula (1). The diimmonium compound represented by the Formula (1) has high shielding property for the near infrared range, broad shielding in the near infrared range, and high transmittance in the visible light range.

R₁ to R₈ in Formula (1) may be the same or different from each other, and specific examples thereof include a hydrogen atom, an alkyl group, a halogenalkyl group, a cyanoalkyl group, an aryl group, an alkenyl group, an aralkyl group, an alkynyl group, a hydroxyl group, a phenyl group, and a phenylalkylene group that are substituted or unsubstituted, and Ring A and Ring B may have a substituent.

In groups of R₁ to R₈, preferable examples of the halogen atom include fluorine, chlorine, and bromine; preferable examples of the alkyl group are a methyl group, an ethyl group, an n-propyl group, an iso-propyl group, an n-butyl group, an iso-butyl group, a t-butyl group, an n-amyl group, an n-hexyl group, an n-octyl group, a 2-hydroxyethyl group, a 2-cyanoethyl group, a 3-hydroxypropyl group, a 3-cyanopropyl group, a methoxyethyl group, an ethoxyethyl group, and a butoxyethyl group; preferable examples of the alkoxy group include a methoxy group, an ethoxy group, a propoxy group, and a butoxy group; preferable examples of the aryl group include a phenyl group, a fluorophenyl group, a chlorophenyl group, a tolyl group, a diethylaminophenyl group, and a naphthyl group; preferable examples of the aralkyl group include a benzyl group, a p-fluorobenzyl group, a p-chlorophenyl group, a phenylpropyl group, and a naphthylethyl group; and preferable examples of the amino group include a dimethylamino group, a diethylamino group, a dipropylamino group, and a dibutylamino group.

Examples of X⁻ include a fluorine ion, a chlorine ion, a bromine ion, an iodine ion, a perchlorate ion, a hexafluoroantimonic acid ion, a hexafluorophosphoric acid ion, a tetrafluoroboic acid ion, a tetraphenylboric acid ion represented by the above Formula (2) (the ring C may have a substituent), and sulfoneimide represented by the above Formula (3) (R₁₃ and R₁₄ may be the same or different from each other, and each represents a fluoroalkyl group or a fluoroalkylene group formed by them in combination). However, in the invention, it is not limited to those described above. Some of these are commercially available, and preferably used are, for example, KayasorbIRG-068 manufactured by Nippon Kayaku Co., Ltd. and CIR-RL manufactured by Japan Carlit Co., Ltd.

For example, as the dithiol compound having a near infrared absorbing function, the compound represented by the above Formula (4) is preferably used.

Specific examples of R₉ to R₁₂ in the above Formula (4) include a halogen atom such as fluorine, chlorine, and bromine; an alkyl group such as a methyl group, an ethyl group, an n-propyl group, an iso-propyl group, an n-butyl group, an iso-butyl group, a t-butyl group, an n-amyl group, an n-hexyl group, an n-octyl group, a 2-hydroxyethyl group, a 2-cyanoethyl group, a 3-hydroxypropyl group, a 3-cyanopropyl group, a methoxyethyl group, an ethoxyethyl group, and a butoxyethyl group; an alkoxy group such as a methoxy group, an ethoxy group, a propoxy group, and a butoxy group; an aryl group such as a phenyl group, a fluorophenyl group, a chlorophenyl group, a tolyl group, a diethylaminophenyl group, and a naphthyl group; an aralkyl group such as a benzyl group, a p-fluorobenzyl group, a p-chlorophenyl group, a phenylpropyl group, and a naphthylethyl group; and an amino group such as a dimethylamino group, a diethylamino group, a dipropylamino group, and a dibutylamino group. Preferable examples of commercially available products include MIR-101 manufactured by Midori Kagaku Co., Ltd.

As the phthalocyanine compound, preferably used are, for example, EXcolor IR-1, EXcolor IR-2, EXcolor IR-3, EXcolor IR-4, TXEX-805K, TXEX-809K, TXEX-810K, TXEX-811K, and TXEX-812K manufactured by Nippon Shokubai Co., Ltd.

As the cyanine compound, for example, CY17 manufactured by Nippon Kayaku Co., Ltd., SD50 manufactured by Sumitomo Seika Chemicals Co., Ltd., and NK-5706 manufactured by Hayashibara Biochemical Lab., Inc. can be preferably used.

It is noted that near infrared ray absorbents (near infrared ray shielding agent) described above are some examples of each near infrared ray absorbent that can be used in the invention, and the near infrared ray absorbent that can be used in the invention is not limited to those described above.

Available examples of the resin binder used to form the near infrared ray absorbing layer include resins such as an acrylic resin, a polyester resin, a polycarbonate resin, a polyurethane resin, a polyolefin resin, a polyimide resin, a polyamide resin, a polystyrene resin, a cycloolefin resin, a polyallylate, and a polysulphone resin. The layer prepared by blending coloring matters or pigments with near infrared ray absorbing property into the resin binder can be formed by applying a coating liquid containing these materials. Known methods can be used as the coating method, and examples thereof include a method using a rod or wire bar, various coating methods such as a micro gravure coating method, a gravure coating method, a die coating method, a curtain coating method, a lip coating method, and a slot coating method, a calendar coating method, and a cast coating method.

The near infrared ray absorbent may be blended into any layers such as the hard coat layer, anti-glare layer, and anti-static layer to allow these layers to have a function of absorbing near infrared ray other than the functions, which these layers possess essentially.

The layer having an ultraviolet ray absorbing function (an ultraviolet ray absorbing layer) is a layer that absorbs an ultraviolet ray with a wavelength of 400 nm or less. It is preferable that such a layer absorbs effectively an ultraviolet ray with a wavelength of 400 nm or less and also absorbs at least 80% of a wavelength of 350 nm. For example, the ultraviolet ray absorbing layer may be formed by blending the ultraviolet absorbent into the resin binder.

Examples of the resin binder used in the formation of the ultraviolet absorbent include an acrylic resin, a polyester resin, a polycarbonate resin, a polyurethane resin, a polyolefin resin, a polyimide resin, a polyamide resin, a polystyrene resin, a cycloolefin resin, a polyallylate resin, and a polysulphone resin.

Any inorganic or organic ultraviolet ray absorbents is usable as the ultraviolet ray absorbent absorbing the ultraviolet ray with a wavelength of 400 nm or less, and the organic ultraviolet ray absorbent is practical. Further it is preferable that an organic ultraviolet ray absorbent has a maximum absorption between 300 to 400 nm and effectively absorbs light in that range. Examples thereof include a benzotriazole ultraviolet ray absorbent, a benzophenone ultraviolet absorbent, a salicylic acid ester ultraviolet ray absorbent, an acrylate ultraviolet absorbent, an oxalic acid anilide ultraviolet ray absorbent, and a hindered amine ultraviolet absorbent. They may be used singly or in combination of several kinds thereof. Stability can be improved by blending the ultraviolet ray absorbent described above and a hindered amine light stabilizer or an antioxidant. Further, by use of a plastic film containing (by kneading, etc.) an ultraviolet ray absorbent as a base material, the base material may be used as a alternative layer of the ultraviolet ray absorbent layer.

The ultraviolet absorbent layer can be formed by applying a coating liquid containing these materials. known methods can be used as the coating method, and examples thereof include a method using a rod or wire bar, various coating methods such as a micro gravure coating method, a gravure coating method, a die coating method, a curtain coating method, a lip coating method, and a slot coating method, a calendar coating method, and a cast coating method.

The ultraviolet ray absorbent may be blended into any layers such as the hard coat layer, the anti-glare layer, and the anti-static layer to allow these layers to have a function of absorbing ultraviolet ray other than the function which is essential for the layer. Alternatively, both the near infrared ray absorbent and ultraviolet ray absorbent may be blended therein.

The layer having a color correcting function is a layer used to correct the color balance of colors displayed on a display, and examples thereof include a layer of cutting orange light with a wavelength 580 to 610 nm emitted from neon, etc. (having a Ne cutting function) in a plasma display and the like. The layer having a color correcting function (a color correcting layer) can be formed by applying a coating liquid containing a color correcting agent such as a pigment for color correction and a resin binder. Available examples of the resin binder used to form the color correcting layer include resins such as an acrylic resin, a polyester resin, a polycarbonate resin, a polyurethane resin, a polyolefin resin, a polyimide resin, a polyamide resin, a polystyrene resin, a cycloolefin resin, a polyallylate, and a polysulphone resin.

Depending on applications, various coloring matters can be used as the coloring matter for color correction, and examples thereof include coloring matters such as cyanine (polymethine), quinine, azo, indigo, polyene, spiro, porphyrin, phthalocyanine, naphthalocyanine, and cyanine coloring matters, but not limited thereto. Coloring matters such as cyanine, porphyrin, and pyrromethene can be used for the purpose of cutting orange light with wavelengths of 580 to 610 nm emitted from neon etc. in a plasma display.

Any known method can be used as the coating method that can be used when the color correcting layer is formed, and specific examples include a method using a rod or wire bar, various coating methods such as a micro gravure coating method, a gravure coating method, a die coating method, a curtain coating method, a lip coating method, and a slot coating method, a calendar coating method, and a cast coating method.

The coloring matter for color correction may be blended into any layers such as the hard coat layer, anti-glare layer, and anti-static layer to allow these layers to have a function of correcting color other than the function which is essential for the layer. Further, the near infrared ray absorbent, the ultraviolet ray absorbent, etc. may be blended into the color correcting layer.

In the invention, a layer having an ND filter function of neutral gray (an ND filter layer) may be provided. Any ND filter layer is available as long as it has generally transmittance of about 40 to 80%, and it can be formed using known methods with known materials. In a display device using a fluorescent substance such as a plasma display, a CRT, a fluorescent display tube, and a field emission type display, light is emitted from the fluorescent substance by irradiating the coated fluorescent substance with an electron beam or an ultraviolet ray to make display with a transmitted light through a fluorescent face or a reflected light from a fluorescent face. Because the fluorescent substance is generally white and has high reflectance, there are many reflections of the external light on the fluorescent face. For this reason, deterioration in display contrast due to reflection of the external light has conventionally become a problem in a display device using a fluorescent substance. This problem can de decreased by providing an ND filter layer.

Further, a layer having a heat radiation function, a shock relieving function, an anti-scattering function, etc. may be laminated as the functional layer.

Examples of the transfer support having the functional layer include those having the following layer configuration.

[1] Support/Hard Coat/Antireflective Layer

[2] Support/Anti-Glare or Anti-Static Hard Coat/Antireflective layer

[3] Support/Hard Coat/Anti-Fouling Antireflective layer

[4] Ultraviolet Ray Absorbing Support/Anti-Glare or Anti-Static Hard Coat/Antireflective layer

[5] Ultraviolet Ray Absorbing Support/Hard Coat/Anti-Fouling Antireflective layer

[6] Ultraviolet Ray Absorbing Support/Anti-Glare or Anti-Static Hard Coat/Anti-Fouling Antireflective layer

[7] Near Infrared Ray Absorbing Layer/Support/Hard Coat/Antireflective layer

[8] Near Infrared Ray Absorbing Layer/Support/Anti-Glare or Antistatic Hard Coat/Antireflective layer

[9] Near Infrared Ray Absorbing Layer/Support/Hard Coat/Anti-Fouling Antireflective layer

[10] Near Infrared Ray Absorbing Layer/Ultraviolet Absorbing Support/Anti-Glare or Anti-Static Hard Coat/Antireflective layer

[11] Near Infrared Ray Absorbing Layer/Ultraviolet Absorbing Support/Hard Coat/Anti-Fouling Antireflective layer

[12] Near Infrared Ray Absorbing Layer/Ultraviolet Absorbing Support/Anti-Glare or Anti-Static Hard Coat/Anti-Fouling Antireflective layer

With the structures of [1] to [6], an electromagnetic shielding material is transferred onto a support through a second adhesive or pressure-sensitive adhesive containing a near infrared ray absorbent, to thereby form an electromagnetic wave shielding laminate of the invention also having a near infrared ray absorbing function without providing a near infrared ray absorbing layer.

With the structures of [7] to [12], an electromagnetic wave shielding laminate of the invention can be formed by transferring an electromagnetic shielding material onto a near infrared ray absorbing layer through an adhesive or pressure-sensitive adhesive.

The structural examples given herein show only some examples of the transfer support, and the layer structure of the transfer support may be of course other than these. However, in the invention, with the electromagnetic wave shielding material it is only required to be transferred onto the transfer support through the second adhesive or pressure-sensitive adhesive layer regardless of whether the second adhesive or pressure-sensitive adhesive has a function or not.

The laminate of the invention is formed by transferring a geometric-form electromagnetic wave shielding material onto a transfer support and then burying the electromagnetic wave shielding material further into an adhesive or pressure-sensitive adhesive such as a second adhesive or pressure-sensitive adhesive depending on necessity. Examples of the method of burying the electromagnetic wave shielding material further into the second adhesive or pressure-sensitive adhesive include (1) a method of laminating a separator onto the electromagnetic wave shielding material, followed by pressing or heating and pressurizing, and (2) a method of placing an adhesive or pressure-sensitive adhesive layer face of a separator having a third adhesive or pressure-sensitive adhesive layer on the electromagnetic wave shielding material, followed by pressing or heating and pressurizing. In the methods (1) and (2), the adhesive or pressure-sensitive adhesive is fluidized by being pressed or heated and pressed, and flows into the opening of the electromagnetic wave material (a metal mesh opening) to fill the opening part with the adhesive or pressure-sensitive adhesive. At this time, by appropriately setting the film thickness of the adhesive or pressure-sensitive adhesive layer and the conditions of heating and pressurizing, the electromagnetic wave shielding material can be formed so as to be covered completely with the adhesive or pressure-sensitive adhesive, and also so as to be at least partly exposed from the adhesive or pressure-sensitive adhesive. Further, the electromagnetic wave shielding material is preferably covered with the second adhesive or pressure-sensitive adhesive by sucking the second adhesive or pressure-sensitive adhesive or expanding the second adhesive or pressure-sensitive adhesive. Moreover, the opening of the electromagnetic wave shielding material can be filled with the adhesive or pressure-sensitive adhesive by (3) a method of applying a new adhesive or pressure-sensitive adhesive onto the electromagnetic wave shielding material. The adhesive or pressure-sensitive adhesive used for application may be an adhesive or pressure-sensitive adhesive other than the second adhesive or pressure-sensitive adhesive. In this case, by adjusting the amount of the adhesive or pressure-sensitive adhesive used for application, a part of the electromagnetic shielding material may be exposed from the adhesive or pressure-sensitive adhesive, or the entire face of the electromagnetic wave shielding material may be covered with the adhesive or pressure-sensitive adhesive. At least an opening of the electromagnetic wave shielding material is covered with the adhesive or pressure-sensitive adhesive, so that the laminate can be directly pasted onto a display panel and display related members through the adhesive or pressure-sensitive adhesive.

FIGS. 1, 2 and 3 show some examples of the laminate according to the invention.

In the laminate in FIG. 1, an electromagnetic wave shielding layer is formed in a state that a hard coat layer 4 and an antireflective layer 5 are provided on one face of a transfer support 1, a near infrared ray absorbing layer 6 is provided on the other face, and a part of an electromagnetic wave shielding material 2 is buried in a second adhesive or pressure-sensitive adhesive layer 3 on the near infrared ray absorbing layer 6.

On the other hand, in the laminate in FIG. 2, an electromagnetic wave shielding layer is formed, similarly to FIG. 1, such that a hard coat layer 4 and an antireflective layer are provided on one face of a transfer support 1 and a part of electromagnetic wave shielding material 2 is buried into a second adhesive or pressure-sensitive adhesive layer 3 on the other face.

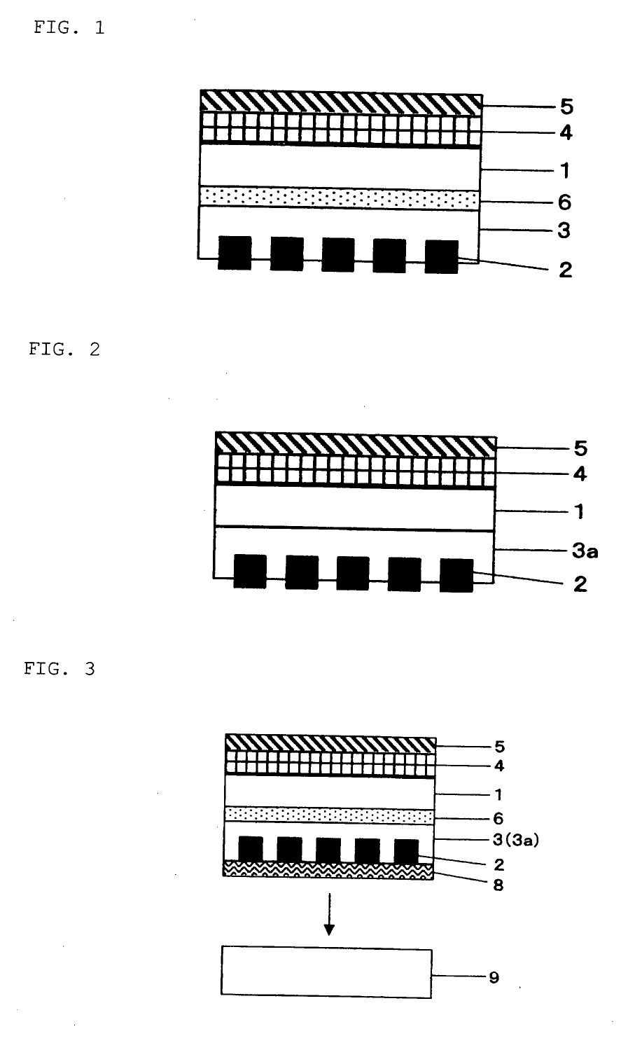

Further, the laminate in FIG. 3 has the same structure as that in FIG. 1 except that the entire opening of the electromagnetic wave shielding material 2 is filled with the adhesive or pressure-sensitive adhesive 3. In addition, an adhesive or adhesive layer 8 containing a color correcting agent is provided on the electromagnetic wave shielding material of the electromagnetic wave shielding laminate in order to paste the laminate to a plasma display panel 9.

The electromagnetic wave shielding laminate obtained according to the invention can be preferably used as the front face of a display, particularly, the front face plate of a plasma display panel. When used as the front face plate of a plasma display panel, the electromagnetic wave shielding material side is preferably pasted to the plasma display panel directly, or preferably pasted to a transparent base material arranged in the front face of the panel. At that time, they may be pasted using an adhesive or pressure-sensitive adhesive. When the electromagnetic wave shielding material is buried into the second adhesive or pressure-sensitive adhesive it can be pasted with the second adhesive or pressure-sensitive adhesive and it is. Therefore this form is preferable because there is no necessity of providing a new adhesive or pressure-sensitive adhesive layer for pasting the electromagnetic wave shielding laminate.

When an adhesive or pressure-sensitive adhesive is provided in the obtained electromagnetic wave shielding laminate and the laminate is pasted directly to the plasma display, additives may be added to the adhesive or pressure-sensitive adhesive. Examples of the additive include a material having a function such as a near infrared ray absorbing function, a color correcting function, or an ultraviolet ray absorbing function. For example, the electromagnetic wave shielding laminate having the configurations [1] to [12] may be pasted directly to the plasma display by use of an adhesive or pressure-sensitive adhesive containing a color correcting agent. One example thereof is shown in FIG. 3.

Moreover, the electromagnetic wave shielding material is preferably grounded through a conductive part. For example, an electromagnetic wave shielding mesh corresponding to the size of the display is produced, and its peripheral edge part is made to be a frame form in order to give physical strength to the electromagnetic wave shielding material. Alternatively, the electromagnetic wave shielding material is formed on the entire surface, and then earth tapes are pasted and an earth is formed physically by conducting methods such as a wire bonding and a stapler to provide conduction. By this way, the electromagnetic wave shielding is preferably made certain.

Hereinafter, the present invention will be specifically explained based on examples, but the invention is not limited thereto.

In the examples and comparative examples, a haze value and a visual light transmittance were measured with following methods.

### (Haze Value)

It was measured with a haze meter NHD2000 manufactured by Nippon Denshoku Industries Co., Ltd.

### (Visible Light Transmittance)

An average value of transmittance was measured in the range of 400 nm to 700 nm using a spectrophotometer, V-570 manufactured by JASCO Cooperation.

### EXAMPLE 1

As a transfer support, used was a polyethylene terephthalate film of 100-μm in thickness (A-4300 manufactured by Toyobo Co., Ltd.), on both surfaces of which an easily adhesive treatment had been applied. On one surface of the support, a hard coat layer of about 10 μm in thickness (dried film thickness) was formed by applying a coating liquid comprising an ultraviolet ray curing type resin (AGS102 manufactured by Toyo Ink MFG. Co., Ltd.) by means of a micro gravure method. LR753 (manufactured by Nippon Kayaku Co., Ltd.) with film thickness of 0.1 μm was then laminated on the hard coat layer as an antireflective layer. The visual reflectance was 1.0 or less.

On the back of the support to the hard coat layer, a near infrared ray absorbing layer of about 10 μm in thickness (dried film thickness) was provided by applying a coating liquid including 100 parts by mass of an acrylic resin (Foret manufactured by Soken Chemical & Engineering Co., Ltd.), 2 parts by mass of near infrared ray absorbents (diimmonium-base and phthalocyanine-base), and 20 parts by mass of a solvent (dioxolane) with a micro gravure method. Furthermore, the adhesive face of a sheet, on a separator of which a second adhesive or pressure-sensitive adhesive has been applied by applying BPS5896 manufactured by Toyo Ink MFG. Co., Ltd. to form a adhesive layer of 18 μm in thickness (dried film thickness) in advance, was pasted to the near infrared ray absorbing layer.

On the other hand, as a releasable support base material (support), used was a polyethylene terephthalate film of 100-μm in thickness (A-4100 manufactured by Toyobo Co., Ltd.), on one surface of which an easily adhesive treatment has been applied. On the easily adhesive face of the base material, a layer of about 10 μm in thickness (dried film thickness) was formed by applying, with a comma coating method, a coating liquid including 5 parts by pass of a solvent (toluene) and 100 parts by mass of an adhesive (first adhesive or pressure-sensitive adhesive) (FS223 manufactured by Toyo Ink MFG. Co., Ltd.), the adhesive force of which was decreased by ultraviolet irradiation. Then, an electrolytic copper foil of 10 μm in thickness (PBN-10 manufactured by Nippon Denkai, Ltd.) was pasted on the layer.

Thereafter, a dry film resist for etching, AQ1558 manufactured by Asahi Kasei Electronics Corporation, was pasted on the copper face by thermal lamination, light exposed with an ultraviolet ray of about 200 mJ/cm² through a lattice-shaped mask, and then developed with a 1% aqueous Na₂CO₃ solution. Subsequently, etching thereof was conducted using a ferric chloride solution with a specific gravity of about 1.50 at a temperature of about 60° C. with a soaking time of about 2 minutes. Then, a resist stripping was conducted with a 20% aqueous NaOH solution to obtain a geometric-form electromagnetic wave shielding material, and further irradiation of 1000 mJ/cm² was conducted from the base material side with an ultraviolet ray (high pressure mercury) lamp to vanish the adhesive force of the resin.

The separator of the transfer support having the functional layers formed thereon was peeled off. The second adhesive or pressure-sensitive adhesive of the transfer support was pasted to the electromagnetic wave shielding material side of the electromagnetic wave shielding material formed on the releasable support. The releasable support was peeled off from the transfer support after heating and pressing using a laminating roll to separate the electromagnetic wave shielding material from the first adhesive or pressure-sensitive adhesive, of which the adhesive force had been decreased, to thereby obtain the electromagnetic wave shielding laminate with a layer configuration shown in FIG. 1.

The electromagnetic wave shielding laminate obtained had one layer each of a supporting base material and an adhesive or pressure-sensitive adhesive layer, and had haze of 2% and visual light transmittance of 85%, thus being obtained an electromagnetic wave shielding laminate with a high transparency and low haze.

### EXAMPLE 2

As a transfer support base material, used was a polyethylene terephthalate film of 100-μm in thickness (A-4300 manufactured by Toyobo Co., Ltd.), on both surfaces of which an easily adhesive treatment had been applied. On one surface of the base material, a hard coat layer of about 10 μm in thickness (dried film thickness) was formed by applying a coating liquid comprising an ultraviolet ray curing type resin, AGS102 manufactured by Toyo Ink MFG. Co., Ltd., with a micro gravure method. LR753 manufactured by Nippon Kayaku Co., Ltd. with film thickness of 0.1 μm was laminated on the hard coat layer as an antireflective layer. The visual reflectance was 1.0 or less.

On the back of the support to the hard coat layer, an adhesive face of a sheet was pasted, the sheet having been formed by coating on a separator at 18 μm in thickness (dried film thickness) in advance a coating liquid comprising 100 parts by mass of the second adhesive or pressure-sensitive adhesive, BPS5896 manufactured by Toyo Ink MFG. Co., Ltd., 2 parts by mass of near infrared ray absorbents (diimmonium-base and phthalocyanine-base), and 20 parts by mass of a solvent (dioxolane).

On the other hand, as a releasable support base material, used was a polyethylene terephthalate film of 100 μm in thickness (A-4100 manufactured by Toyobo Co., Ltd.), on one side of which an easily adhesive treatment was applied. On the easily adhesive face of the base material, a layer of 15 μm in thickness (dried film thickness) was formed by applying a coating liquid compring 5 parts by mass of a solvent (toluene) and 100 parts by mass of an adhesive, FS223 manufactured by Toyo Ink MFG. Co., Ltd., the adhesive force of which was decreased by ultraviolet irradiation. Then, an electrolytic copper foil, PBN-10 manufactured by Nippon Denkai, Ltd. of 10 μm in thickness was pasted on the layer.

Thereafter, a dry film resist for etching, AQ1558 manufactured by Asahi Kasei Electronics Co., Ltd., was pasted on the copper face by thermal lamination, light exposed in an amount of about 500 mJ/cm² with an ultraviolet ray through a lattice-shaped mask, and then developed with a 1% aqueous Na₂CO₃ solution. Subsequently, etching thereof was conducted using a ferric chloride solution with a specific gravity of about 1.50 at a temperature of about 60° C. with a soaking time of about 2 minutes. Then, a resist stripping was conducted with a 20% aqueous NaOH solution to obtain a geometric-form electromagnetic wave shielding material.

The separator of the transfer support having the functional layers formed thereon was peeled off. The second adhesive or pressure-sensitive adhesive containing a near infrared ray absorbing functional agent of the transfer support was pasted to the electromagnetic shielding material side of the electromagnetic wave shielding material formed on the releasable support. Irradiation in an amount of 500 mJ/cm² was conducted from the side of releasable support base material with an ultraviolet ray (high pressure mercury) lamp to decrease the adhesive force of the adhesive. Then, the releasable support was peeled off from the transfer support and thereby the electromagnetic wave shielding material was peeled off from the first adhesive or pressure-sensitive adhesive, the adhesive force of which was decreased, to obtain the electromagnetic wave shielding laminate with a layer configuration shown in FIG. 2.

The electromagnetic wave shielding laminate obtained had one layer each of a supporting base material and an adhesive or pressure-sensitive adhesive layer, and had haze of 2% and visual light transmittance of 85%, thus being obtained an electromagnetic wave shielding laminate with a high transparency and low haze.

### COMPARATIVE EXAMPLE 1

As a base material, used was a polyethylene terephthalate film of 100 μm in thickness (A-4300 manufactured by Toyobo Co., Ltd.), on both surfaces of which an easily adhesive treatment had been applied. On the easily adhesive treated face of the base material, a coating liquid comprising 100 parts by mass of an acrylic resin, Foret manufactured by Soken Chemical & Engineering Co., Ltd., 2 parts by mass of near infrared ray absorbents (diimmonium-base and phthalocyanine-base), and 20 parts by mass of a solvent, dioxolane, was applied at about 10 μm thickness (dried film thickness) with a micro gravure method to form a near infrared ray absorbing layer. Thereby, a base material with the near infrared ray absorbing layer was obtained.

Next, as a base material, used was a polyethylene terephthalate film of 100 μm in thickness (A-4300 manufactured by Toyobo Co., Ltd.), on both surfaces of which an easily adhesive treatment had been applied. On the easily adhesive treated face of the base material, a hard coat layer of about 10 μm in thickness (dried film thickness) was formed by applying a coating liquid of an ultraviolet ray curing type resin, AGS102 manufactured by Toyo Ink MFG. Co., Ltd., by a micro gravure method. LR753 manufactured by Nippon Kayaku Co., Ltd. with film thickness of 0.1 μm was laminated on the hard coat layer as an antireflective layer, to obtain a base material with a hard coat layer having a visual reflectance of 1.0 or less.

Further, an adhesive, AD76-P1 manufactured by Toyo-Morton, Ltd., with good adhesiveness with copper was applied on a polyethylene terephthalate film of 100 μm in thickness (A-4300 manufactured by Toyobo Co., Ltd.) at about 10 μm thickness (dried film thickness) by a micro gravure method. Then, an electrolytic copper foil, PBN-10 manufactured by Nippon Denkai Co., Ltd., was pasted on the film, and the resultant film was subjected to reaction aging at 60° C. for about 7 days.

Thereafter, a dry film resist for etching was pasted on the copper face by thermal lamination, irradiated in an amount of about 200 mJ/cm² with an ultraviolet ray through a lattice-shaped mask, and then developed with a 1% Na₂CO₃ solution. Subsequently, etching thereof was conducted using a ferric chloride solution with a specific gravity of about 1.50 at a temperature of about 60° C. with a soaking time of about 2 minutes. Then, a resist stripping was conducted with an aqueous NaOH solution of 1 mol/L to obtain a base material with the electromagnetic wave shielding material.

Further, an acrylic resin was applied to a mesh opening of the electromagnetic wave shielding material in a thickness of 20 μm that was thicker than or equal to the thickness of the copper foil, to thereby seal the opening. Thereafter, the sheet was irradiated in an amount of 300 mJ/cm² with a high-pressure mercury lamp.

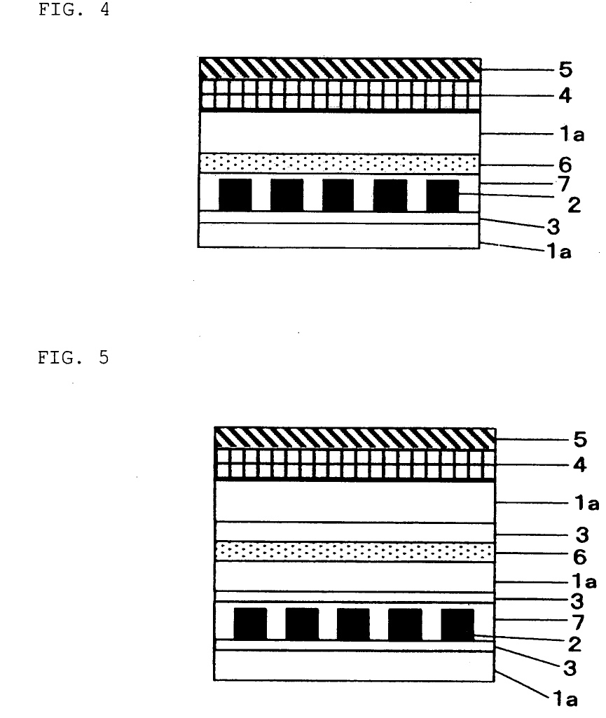

The base material with a hard coat layer, the base material with a near infrared ray absorbing layer, and the base material with an electromagnetic wave shielding material were pasted together using two sheets produced in advance by laminating the adhesive of BPS5969 in 20 μm thickness (dried film thickness) between two separators, and heating and pressurizing it using a laminator, to thereby obtain an electromagnetic wave shielding laminate with a layer structure shown in FIG. 5.

The electromagnetic wave shielding laminate obtained had three supporting base material layers and two adhesive or pressure-sensitive adhesive layers, and had also haze of 10% and visual light transmittance of 75%. This had many layers of base materials, deteriorated transparency and high haze as compared with Examples.

There are Summarized and shown the results of the number of the support base materials, the number of the adhesive or pressure-sensitive adhesive layers, the haze value, the visible light transmittance, the weight per unit area, and the handling property of the electromagnetic wave shielding laminate obtained in Examples 1 and 2 and Comparative Example 1 in Table 1.

TABLE 1

| | Number of | Number | | | | |
|---|---|---|---|---|---|---|
| | support | of | | Visual light | | |
| | base | adhesive | Haze | transmittance | Weight | |
| Sample | materials | layers | (%) | (%) | (kg/cm²) | Handling |
| Example 1 | 1 | 1 | 2 | 85 | 249.1 × 10⁻¹⁰ | ◯ |
| Example 2 | 1 | 1 | 2 | 85 | 254.1 × 10⁻¹⁰ | ◯ |
| Comparative | 3 | 2 | 10 | 75 | 575.1 × 10⁻¹⁰ | ◯ |
| Example 1 | | | | | | |

It is confirmed from Table 1 that the electromagnetic wave shielding laminates in Examples are excellent in the aspects of haze, visual light transmittance, and thinness of the member compared with that in Comparative example.

1. A production method for an electromagnetic wave shielding laminate comprising:
a step of forming a geometric-form electromagnetic wave shielding material on a releasable support;
a step of separating the electromagnetic wave shielding material from the releasable support, and
a step of transferring the electromagnetic wave shielding material onto a transfer support, on one or both surfaces of which at least one functional layer with at least one function of conductivity, an anti-reflection function, a reflection-reducing function, a hard-coat property, an anti-glare function, an anti-staining function, a near infrared ray absorbing function, an ultraviolet ray absorbing function, a color correcting function, a radiating function, a Ne cutting function, an anti-scattering function, and a shock relieving function is formed.

2. The production method for an electromagnetic wave shielding laminate according to claim 1, wherein the step of forming a geometric-form electromagnetic wave shielding material on a releasable support comprises:
a step of pasting a metal foil onto the support through a first adhesive or pressure-sensitive adhesive; and
a step of forming the metal foil into a geometric-form by an etching method.

3. The production method for an electromagnetic wave shielding laminate according to claim 1, wherein the first adhesive or pressure-sensitive adhesive is an adhesive of active energy ray adhesive force vanishing type.

4. The production method for an electromagnetic wave shielding laminate according to claim 1, wherein the step of forming an electromagnetic wave shielding material by transferring includes a step of separating the electromagnetic wave shielding material from the releasable support.

5. The production method for an electromagnetic wave shielding laminate according to claims 1, wherein the step of forming an electromagnetic wave shielding material by transferring includes a step of vanishing away an adhesive or pressure-sensitive adhesive force of the first adhesive or pressure-sensitive adhesive by irradiation with active energy rays.

6. The production method for an electromagnetic wave shielding laminate according to claim 1, further comprising a step of conducting a blackening treatment on the geometric-form electromagnetic wave shielding material.

7. The production method for an electromagnetic wave shielding laminate according to claim 1, wherein the electromagnetic wave shielding material is formed by transferring onto a transfer support through a second adhesive or pressure-sensitive adhesive in the step of transferring the electromagnetic wave shielding material.

8. The production method for an electromagnetic wave shielding laminate according to claim 7, wherein the second adhesive or pressure-sensitive adhesive has at leas one function of a near infrared ray absorbing function, a Ne cutting function, a color correcting function, a radiating function, and an anti-scattering function.

9. The production method for an electromagnetic wave shielding laminate according to claim 7 or 8, wherein the electromagnetic wave shielding material formed by transferring onto the transfer support is covered with the second adhesive or pressure-sensitive adhesive.

10. The production method for an electromagnetic wave shielding laminate according to 7 or 8, wherein the electromagnetic wave shielding material formed by transferring onto the transfer support is covered with the second adhesive or pressure-sensitive adhesive, and a part of the material is exposed from the second adhesive or pressure-sensitive adhesive.

11. An electromagnetic wave shielding laminate produced by the production method for an electromagnetic wave shielding laminate according to any one of claims 1 to 10.
